(19) United States
(12) Patent Application Publication
(10) Pub. No.: US 2015/0048021 A1
(43) Pub. Date: Feb. 19, 2015

(54) SEPARATION DEVICES FOR PROCESSING WASTE FOODS DISPOSED OF VIA SINKS

(71) Applicant: Lyle Bates, Puyallup, WA (US)

(72) Inventor: Lyle Bates, Puyallup, WA (US)

(21) Appl. No.: 14/186,887

(22) Filed: Feb. 21, 2014

Related U.S. Application Data
(60) Provisional application No. 61/768,098, filed on Feb. 22, 2013.
(60) Provisional application No. 61/891,048, filed on Oct. 15, 2013.

(51) Int. Cl. B01D 29/94; B01D 29/00

(52) U.S. Cl. CPC B01D 29/94; B01D 29/0097
USPC 210/435

(57) ABSTRACT

In some arrangements, a separation device can receive a discharge from a sink or garbage disposal unit and separate the discharge into a fluid portion and a solids portion. The separation device can include an inlet for receiving the discharge and an outlet for passing the fluid portion to a waste line. The separation device can include a screen that collects the solids portion and that permits the fluid portion to pass through the screen.

### RELATED APPLICATIONS

This application claims priority to United State Provisional Application No. 61/768,098, filed on Feb. 22, 2013 (“Separation Devices for Processing Garbage Disposal Discharge”) and to U.S. Provisional Application No. 61/891,048, filed on Oct. 15, 2013 (“Separation Devices for Processing Waste Foods Disposed of Via Sinks”). Both of these applications are hereby incorporated by reference in their entirety.

### TECHNICAL FIELD

The present disclosure relates generally to systems for disposing of waste foods disposed of via sinks.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A is an elevation view of a sink and a garbage disposal unit that includes a partial cutaway perspective view of an embodiment of a separation device installed downstream from the garbage disposal unit, wherein the separation device is shown prior to introduction therein of a discharge from the garbage disposal unit;

FIG. 1B is another elevation view of the sink and garbage disposal unit with a partial cutaway perspective view of the separation device of FIG. 1A, wherein the separation device is shown after having separated multiple discharges from the garbage disposal unit;

FIG. 2 is an exploded perspective view of the separation device of FIG. 1A;

FIG. 3 is an enlarged view of a portion of an embodiment of a collection assembly that is compatible with the separation device of FIG. 1A taken along the view line 3 in FIG. 2;

FIG. 4 is an elevation view of a sink and a garbage disposal unit that includes a partial cutaway perspective view of another embodiment of a separation device installed downstream from the garbage disposal unit, wherein the separation device is shown in use with portions of one or more discharges from the garbage disposal exiting from the separation device via two different exit ports;

FIG. 5 is an exploded elevation view of the separation device of 4 with a housing portion thereof shown in cross-section;

FIG. 6 is an elevation view of a sink and a garbage disposal unit that includes a partial cutaway perspective view of another embodiment of a separation device installed downstream from the garbage disposal unit, wherein the separation device is shown in use with portions of one or more discharges from the garbage disposal exiting from the separation device via two different exit ports;

FIG. 7 is an elevation view of a sink and a garbage disposal unit that includes a partial cutaway perspective view of another embodiment of a separation device installed downstream from the garbage disposal unit, wherein the separation device is shown in use with portions of one or more discharges from the garbage disposal exiting from the separation device via two different exit ports and the separate portions being delivered to separate receptacles at an exterior of a structure;

FIG. 8 is an exploded perspective view of another embodiment of a separation device;

FIG. 9 is an exploded perspective view of another embodiment of a separation device;

FIG. 10 is an elevation view of another embodiment of a separation device installed so as to receive food waste from a garbage disposal unit that is coupled with a sink;

FIG. 11 is an exploded perspective view of the separation device of FIG. 10;

FIG. 12 is an exploded perspective view of the separation device of FIG. 10, which further illustrates a bag that can be used with the separation device;

FIG. 13 is an elevation view of another embodiment of a separation device installed so as to receive food waste directly from a sink;

FIG. 14 is a cross-sectional view of another embodiment of a separation device;

FIG. 15 is a cross-sectional view of another embodiment of a separation device;

FIG. 16 is a cross-sectional view of another embodiment of a separation device;

FIG. 17 is a cross-sectional view of another embodiment of a separation device;

FIG. 18 is an enlarged view of a portion of the separation device of FIG. 15;

FIG. 19 is a cross-sectional view of another embodiment of a separation device;

FIG. 20 is a perspective view of another embodiment of a separation device; and

FIG. 21 is a top plan view of the separation device of FIG. 17.

### DETAILED DESCRIPTION

Embodiments disclosed herein address many problems associated with the disposal of organic (e.g., biodegradable) materials via the waste line of a building (e.g., home, apartment complex, business, etc.) after that organic material has been processed by a garbage disposal unit, which units are also commonly known as waste disposals, garbage disposals, in-sink garbage grinders, etc. For example, it can be desirable to prevent much or all of the organic material from continuing through the waste line of the building and into a localized septic tank or, in other instances, into a water treatment plant (e.g., a government- or industrially-operated sewer system). In some instances, the organic material can lead to the total failure of a septic system due to overwhelming biochemical oxygen demand (B.O.D.) loads caused by the organic material. Similarly, in other instances where the organic material is delivered to a sewer system and/or a wastewater treatment plant, the organic material can add to the costs for treating the wastewater. Indeed, some large cities have banned garbage disposal units in high density areas, such as high rise dwelling units, due to the high expense to treat the extra B.O.D. loads from the organic material.

Many attempts to remedy these negative effects have led to complicated and technical processes that are not conducive to successful or convenient home owner operation. Various embodiments described herein, however, remedy, ameliorate, and/or otherwise address one or more of the foregoing problems. For example, certain embodiments separate ground solids from the effluent, or discharge, from a garbage disposal unit. Various embodiments permit little or no ground solids to then proceed into the waste line. Further, in various embodiments, the ground solids may be collected for other beneficial purposes, such as composting. Some embodiments can have a compact design so as to readily be deployed within the same area (e.g., within the same under-sink cupboard or cabinet) as a garbage disposal unit. Other or further advantages will be apparent from the disclosure herein.

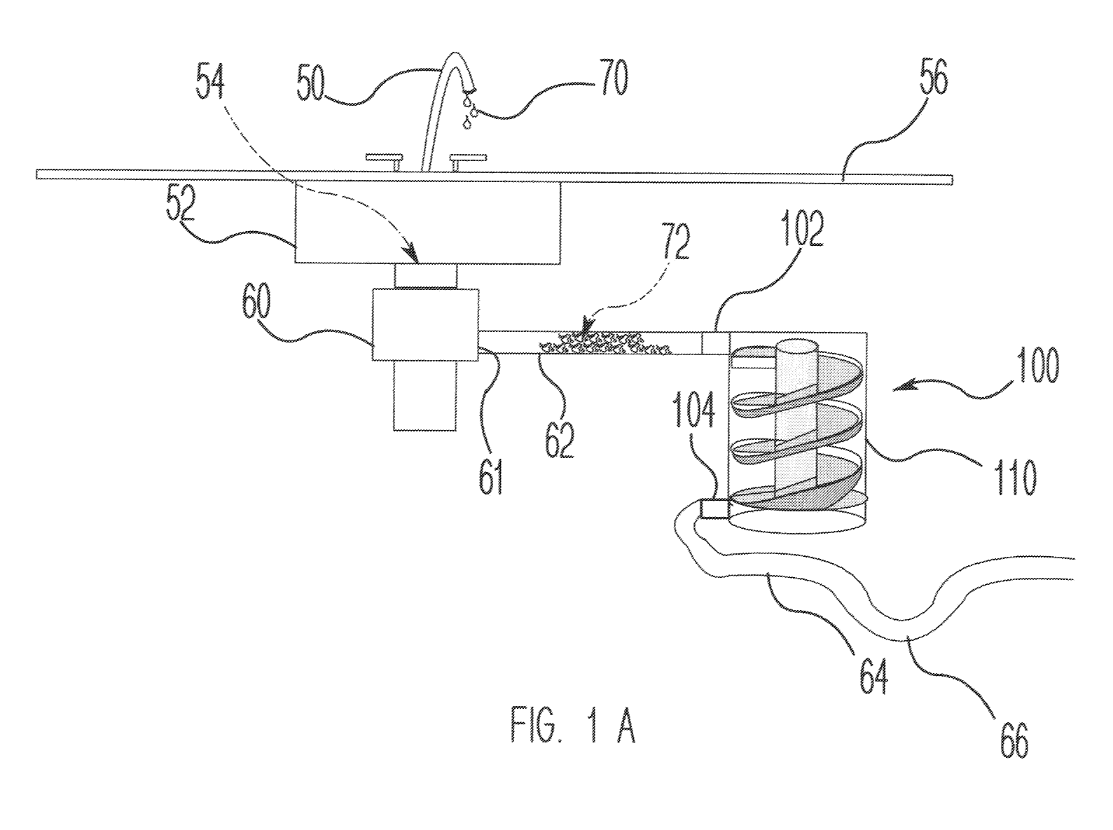

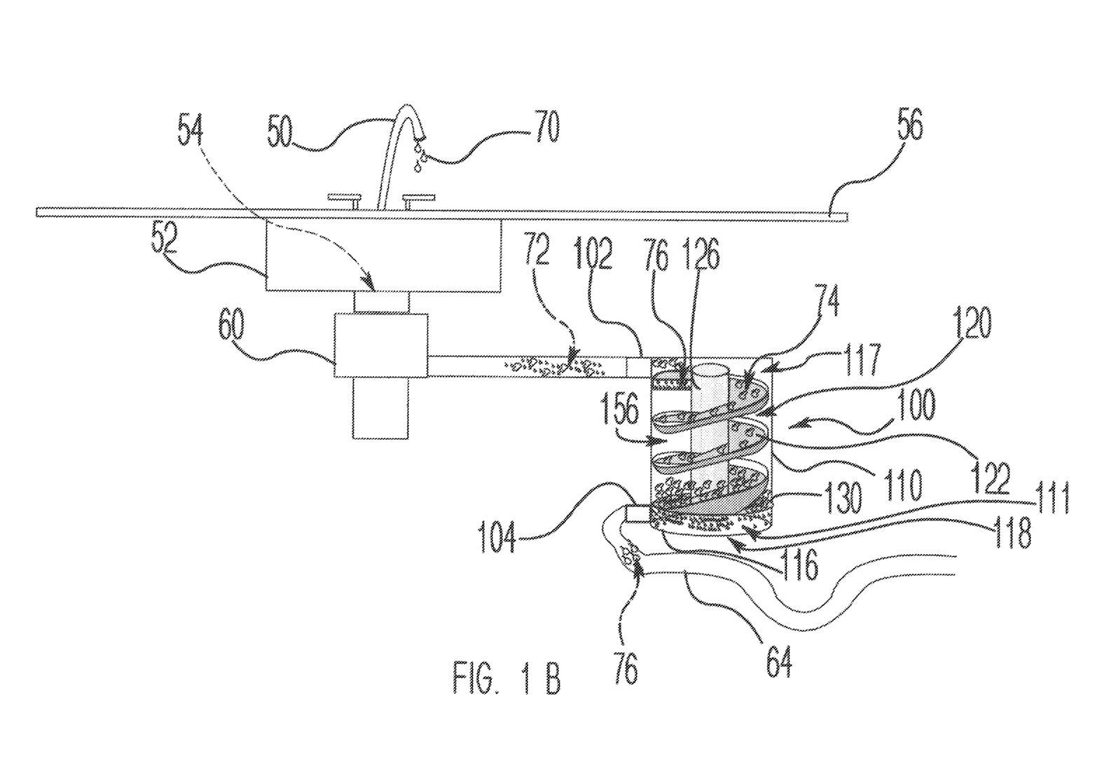

FIG. 1 depicts an embodiment of a separation device 100 that is installed in a typical environment in which the separation device 100 may be used. In particular, the separation device 100 is shown installed below a countertop 56 in the vicinity of a sink 52 and a garbage disposal unit 60. In some instances, both the separation device 100 and the garbage disposal unit 60 can be located within the same under-sink cupboard or cabinet space, and may be accessible through the same or adjacent cupboard or cabinet doors. In many embodiments, the separation device 100 may be used in a household or localized setting, such as in conjunction with a kitchen sink for a house, apartment, restaurant, business, motor home, boat, etc. The separation device 100 thus may be used in a building or other structure. Other suitable environments and contexts in which the separation device 100 can be used are also contemplated.

The separation device 100 can include an inlet 102 and an outlet 104. The inlet 102 can be coupled to the garbage disposal unit 60 in any suitable manner. In the illustrated embodiment, the inlet 102 is fluidly coupled with the garbage disposal unit 60 via a conduit 62. The conduit 62 can include one or more fluid conduits of any suitable variety (e.g., pipes or other fluid lines) that are joined to each other in any suitable fashion. Accordingly, in some embodiments, the inlet 102 can comprise a threaded fitting or other suitable attachment feature for coupling with such piping. In the illustrated embodiment, the inlet 102 is shown as an extension, such as a fitting, that projects horizontally away from a housing 110. In other embodiments, the inlet 102 may project in a different direction and/or may be defined by the housing 110 itself.

In the illustrated embodiment, the inlet 102 is positioned at about the same vertical height as an outlet 61 of the garbage disposal unit 60. Stated otherwise, in some embodiments, the inlet 102 of the separation device 100 and the outlet 61 of the garbage disposal unit 60 can be at about the same distance from of the countertop 56. In other embodiments, the inlet 102 may be higher or lower than the outlet 61 of the garbage disposal unit 60. In certain of the foregoing arrangements, it can be desirable for fluid that drains through the garbage disposal unit 60 to be capable of being transported through the conduit 62 to the inlet 102 without activation of the garbage disposal unit 60. That is, when the garbage disposal unit 60 is in use, it can provide a high momentum to the materials that it delivers through the conduit 62, such that those materials could easily overcome gravity to enter an inlet port 102 that is well above the height of the outlet port 61. However, when the garbage disposal unit 60 is not in use, this momentum is not imparted to the materials. Accordingly, it can be desirable for fluids that drain through the garbage disposal unit 60, when not activated, to readily enter the inlet 102.

In some embodiments, the separation device 100 utilizes gravity in its operation, and may be elongated in a substantially vertical direction to provide a relatively long path over which gravity can act on the fluidic and/or solid components that enter the separation device 100. Having an elongated path, such as described below, that is compacted into a relatively small area can aid in economizing the under-sink space. When the garbage disposal unit 60 grinds a mass of solid organic waste (e.g., solid food items or portions thereof), the resultant discharge 72 is forced, urged, or otherwise delivered through the conduit 62 to the inlet 102. Standard operation of the garbage disposal unit 60 can provide sufficient force to the discharge 72 for it to enter the inlet 102 with a high momentum, as discussed further below, whereas fluids that drain through the garbage disposal unit 60 when not activated can enter the inlet 102 with a small momentum.

The discharge 72 may also be referred to as garbage disposal unit effluent, and it can consist of a combination or mixture of fluid, such as water 70 from a faucet 50 and/or any other fluid disposed of down the drain 54 of the sink 52, and the ground up solids portions of the organic materials disposed of down the drain 54.

As further discussed below, the separation unit 100 is configured to extract solids from the discharge 72 to prevent the extracted solids from passing through a waste line 64. The waste line 64 can be joined to one or more other waste lines of a structure (e.g., building, motor vehicle, boat) within which the countertop 56 is located. In some instances, the waste line 64 ultimately feeds to, or is fluidly connected to, a septic tank at an exterior of the structure or a sewer system that feeds to a water treatment facility. Accordingly, the separation unit 100 can prevent the collected or extracted solids from ultimately being fed to the septic tank or water treatment facility. In various embodiments, the separation unit 100 is configured to extract all or substantially all of the solids from the discharge 72.

The separation unit 100 can be coupled to the waste line 64 via an outlet 104. The outlet 104 can comprise a threaded fitting or other suitable attachment feature for coupling with piping or other conduit structures that define the waste line 64. In the illustrated embodiment, the outlet 104 is shown as an extension, such as a fitting, that projects horizontally away from the housing 110. In other embodiments, the outlet 104 may project in a different direction and/or may be defined by the housing 110 itself.

In some embodiments, the separation unit 100 is installed upstream from a P-trap 66 of the waste line 64, which is generally used to separate the sink 52 and the garbage disposal unit 60 from a pathogenic environment that is downstream from the P-trap 66. In other or further embodiments, an additional P-trap (such as the P-trap 66) may be positioned between the garbage disposal unit 50 and the separation unit 100, or stated otherwise, the conduit 62 may include a P-trap. The additional P-trap may prevent odors from passing from the separation unit 100 through the garbage disposal unit 60 and the drain 54 and into the environment surrounding the sink 52. For example, some embodiments of the separation unit 100 may collect and store organic waste solids for an extended period of time, which may produce undesirable odors. Such embodiments may be substantially airtight so as to prevent odors from escaping the separation unit 100 itself, except via the inlet 102 and/or the outlet 104, which are in fluid communication with an interior of the housing 110. In other or further embodiments, the inlet 102 may comprise a one-way valve or check valve, which can serve prevent odors from passing from the separation unit 100 through the garbage disposal unit 60 and the drain 54 and into the environment surrounding the sink 52 and/or otherwise prevent fluids from returning from the separation device 100 into the garbage disposal unit 60.

FIGS. 1A and 1B show two different stages of operation of the separation unit 100. In FIG. 1A, the separation unit 100 has not yet received an initial discharge from the garbage disposal unit 60. However, a first discharge 72 is shown being delivered to the inlet 102 of the separation unit 100.

In FIG. 1B, the separation unit 100 has acted on multiple discharges from the garbage disposal unit 60, and an additional discharge 72 is shown being delivered to the inlet 102 of the separation unit 100. As further discussed below, the separation unit 100 is configured to remove, extract, or collect solids 74 from the discharges from the garbage disposal unit 60. The term “solids” is used broadly herein to include solid constituents, gelled constituents, and/or any other constituents of a discharge from the garbage disposal unit 60 that are incapable of passing through a grate, membrane, filter, or screen 122 of the separation device 100.

The separation unit 100 can permit liquid 76 to pass through it and exit via the outlet 104 into the waste line 64. In some embodiments, the liquid 76 may include small solids particles therein. For example, in some embodiments, the screen 122 may not extract all solids material from a given discharge 72, but the solids 74 that are collected can significantly reduce the amount of organic material that is delivered to the waste line 64.

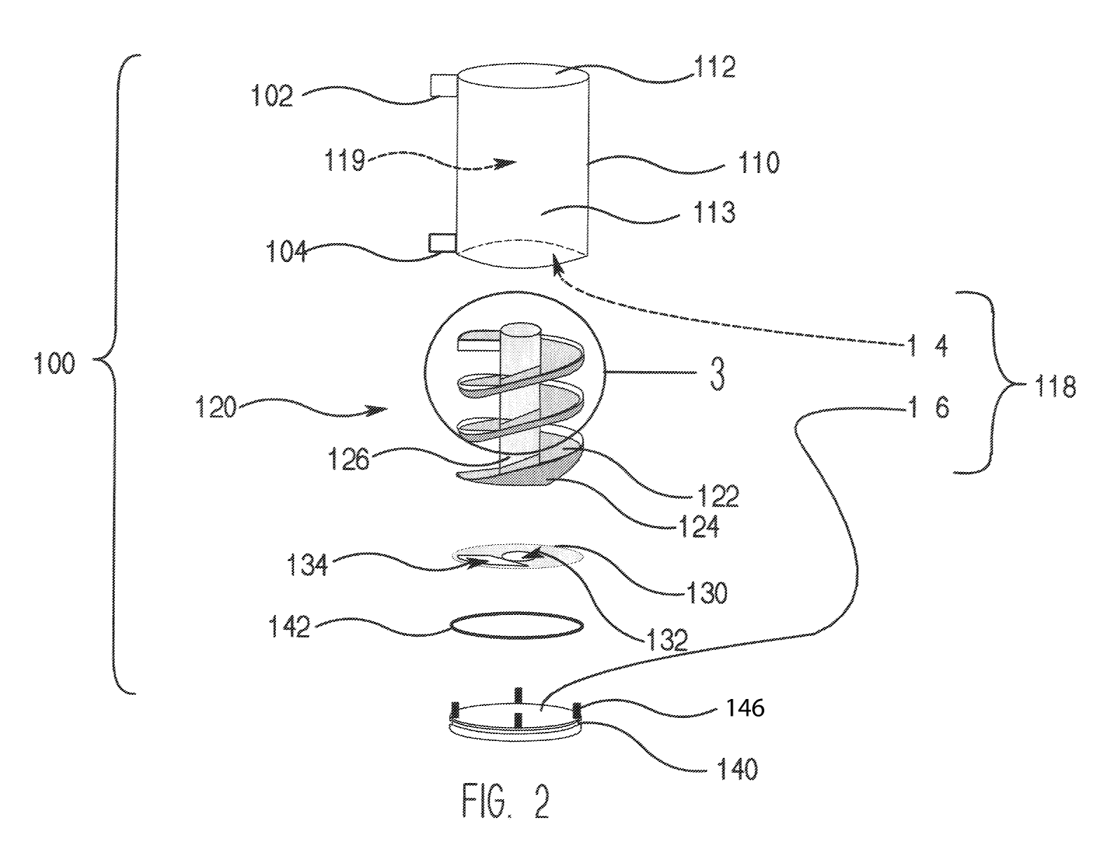

FIG. 2 is an exploded perspective view of the separation device 100 of FIGS. 1A and 1B. The housing 110 can be coupled with the inlet 102 and the outlet 104, as previously described. In some embodiments, the housing 110 includes an upper wall 112 and a side wall 113 that cooperate to define a cavity 119. In the illustrated embodiment, the housing 110 is substantially cylindrical, although other arrangements are possible. The sidewall 113 can define a lower opening 114.

The housing 110 can be configured to couple with a lid or cover 116, which can enclose the cavity 119 when the cover 116 is attached to the housing 110. In some embodiments, the cover 116 includes a groove 140 that is configured to receive a sealing member 142, such as an O-ring. In this or other suitable manners, the cover 116 thus may be configured to couple with housing 110 in an air-tight or fluid-tight manner, which can prevent leaking of the separation device 100 and/or escape of odors from the separation device 100. In some embodiments, the cover 116 includes one or more spacers 146, which are discussed further below.

Together, the lower opening 114 and the cover 116 can function as an expulsion port 118 through which solids 74 that are collected by the separation device 100 may be removed from the separation device 100. An example of such a solids removal procedure is also discussed below.

The separation unit 100 can include a collection assembly 120 that is configured to collect solids 74 from a discharge 72 and is configured to permit fluid 76 from the discharge 72 to pass through. In the illustrated embodiment, the collection assembly 120 includes a screen 122 and a channeling member 124 that extend about a central column or post 126. In some embodiments, the screen 122 and the channeling member 124 each define a helical shape, and each may be referred to as an inclined plane. As used herein, “inclined plane” is a broad term that does not require a surface defined by the inclined plane to be planar. Rather, the inclined plane can include a surface of any suitable shape or geometry that is angled (e.g., relative to a longitudinal axis of the post 126). A generally helical shape, or other suitable compact shape, can provide for a large surface area over which a discharge 72 can interact with the screen 122 in a compact space.

The screen 122 and/or the channeling member 124 can each define an outer perimeter that is complementary to and fits tightly within an inner perimeter of the sidewall 113 of the housing 110. A tight fit may result in a fluid-tight seal between the sidewall 113 and each of the screen 122 and the channeling member 124. For example, in the illustrated embodiment, the inner surface of the sidewall 113 is substantially cylindrical and the outer edges of the screen 122 and the channeling member 124 trace out a helical path bounded by a cylinder. An inner diameter of the sidewall 113 can be about the same or slightly smaller than an outer diameter of the screen 122 and channeling member 124.

The housing 110, the screen 122, and the channeling member 124 can be formed of any suitable material. In some embodiments, the housing 110, the screen 122, and the channeling member 124 may each be rigid. However, in some embodiments, at least an edge portion of the screen 122 and the channeling member 124 may be somewhat more flexible than the housing 110 so as to be slightly compressed by the housing during insertion and form a tight seal with the housing 110. In other or further embodiments, the outer edges of the screen 122 and the channeling member 124 may be formed of a different material than the remaining portions of those structures. For example, the outer edges may include an elastomeric or other resilient material configured to form a seal with the housing. In various embodiments, the housing 110 may comprise a rigid plastic, which in further embodiments, may be transparent, translucent, or otherwise suitably permit viewing into the cavity 119 to determine a fill level of the separation device 100. One or more of the screen 122 and the channeling member 124 may comprise one or more of metal, plastic, rubber, or other suitable materials. In some embodiments, the collection assembly 120 may be formed of a unitary piece of material, such as via molding or other suitable manufacturing techniques. In other embodiments, the screen 122 and the channeling member 124 may be separately attached to the post 126. In either case, in some embodiments, the collection assembly 120 is configured to move together as a single structure that capable of being readily inserted into the housing 110 and removed from the housing 110. Other suitable arrangements are also possible.

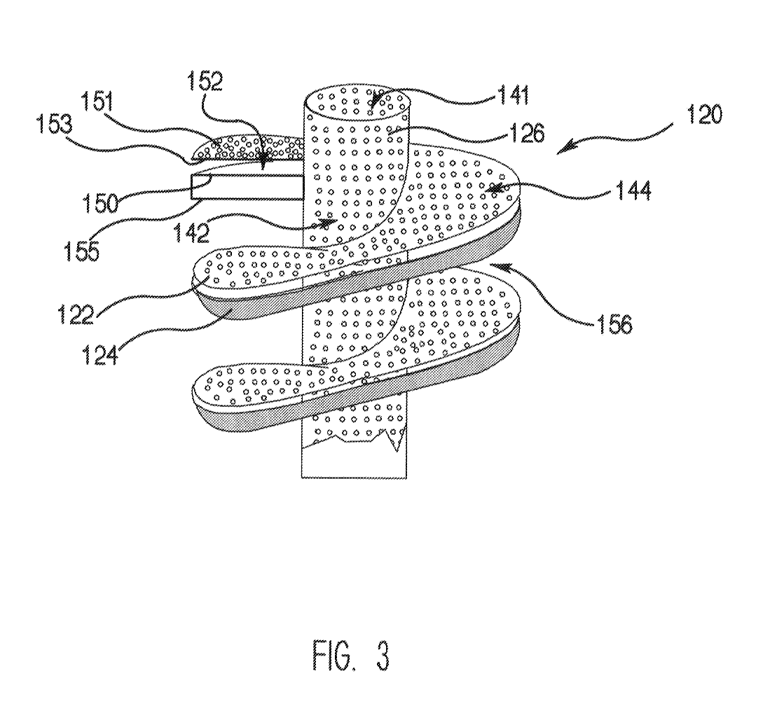

With reference to FIGS. 2 and 3, in some embodiments, the screen 122 can define a plurality of openings 144 through which the fluid 76 can pass. The size of the openings 144 can be selected to prevent at least a portion of the solids content of the discharge 72 from the disposal unit 60 from passing through the screen 122. Accordingly, the screen 122 can collect the solids 74 at an upper surface 151 of the screen 122.

A lower surface 153 of the screen 122 can face an upper surface 150 of the channeling member 124. In some embodiments, the upper surface 150 of the channeling member 124 and the lower surface 153 of the screen 122 are substantially parallel to each other. The upper surface 150 of the channeling member 124 can define a fluid path or fluid channel 152 along which the fluids 76 that are separated from the discharge 72 can be channeled toward the outlet 104. In some embodiments, the fluid channel 152 is further defined or restricted by the sidewall 113 of the housing 110. In various embodiments, the fluid channel 152 is substantially coextensive with the screen 122. That is, a length of the fluid channel 152 can be approximately the same length as the screen 122. In other or further embodiments, the fluid channel 152 can extend along at least a majority of the length of the screen 122.

The upper surface 151 of the screen 122, a lower surface 155 of the channeling member 124, and the sidewall 113 of the housing 110 can cooperate to define a discharge channel 156. In the illustrated embodiment, the discharge channel 156 is substantially helical. As further discussed below, solids portions that have been collected from one or more discharges from the garbage disposal unit 60 may be advanced along the discharge channel 156 by subsequent discharges from the garbage disposal unit 60 due to the high momentum of those subsequent discharges as they enter the separation device 100 through the inlet 102.

In some embodiments, the post 126 may also be configured to separate solids 74 from the fluid 76 in a manner similar to the screen 122. For example, in some embodiments, the screening post 126 is formed of the same or similar material as the screen 122. The post 126 may define a fluid passageway 141 through which separated fluid 76 may pass toward the outlet 104.

Like the screen 122, the screening post 126 may include a plurality of openings 142 that are configured to permit the passage of fluid through them. The openings 142 of the post 126 and the openings 144 of the screen 122 may be uniformly sized. In other embodiments, the openings 142, 144 may be different sizes. In other or further embodiments, each set of openings 142, 144 may include differently sized openings. The size and variations of the openings 142, 144 may be selected based on any desired operational parameter or balancing of considerations, such as, in some instances, by balancing a desire to reduce the amount of organic material that is allowed to enter a septic tank or sewer to a minimum without causing the openings 142, 144 to clog. In various embodiments, a maximum diameter of the openings 144 can be no greater than about 0.1, 0.5, 0.75, 1, 2, 3, 4, or 5 millimeters. In some embodiments, the screen 122 can comprise a filtering sheet (e.g., similar to a coffee filter). In other embodiments, the separation device 100 may include a filtering sheet (not shown) that is separate from the screen 122 and may be configured to rest on the upper surface 151 of the screen 122 and may have openings that are smaller than the openings 144. The filtering sheet may be removable and replaceable.

With reference to FIGS. 1B and 2, in the illustrated embodiment, the separation device 100 includes a screening partition 130 that is configured to separate the cavity 119 of the housing 110 into an upper divergent chamber 117 and a lower fluid collection chamber 111. In the divergent chamber 117, the screen 122 operates to separate the solids 74 constituents from the fluid 76 constituents of the discharges 72. The fluid collection chamber 111 provides a volume into which the separated fluids 76 can gather and then drain through the outlet 104. In some embodiments, the screening partition 130 is positioned above the outlet 104. The screening partition 130 may be formed of the same or similar material as the screen 122, and may be configured to similarly separate the solids 74 from the fluid 76.

In some embodiments, the partition 130 includes an opening 132 that is configured to be positioned at a bottom end of the fluid passageway 141 of the post 126 (see FIG. 3). Accordingly, fluids collected by the post 126 can pass through the opening 132 into the fluid collection chamber 111. The partition 130 can further include an opening 134 that is configured to be positioned at the bottom end of the fluid channel 152 defined by the channeling member 124 (see FIG. 3). Accordingly, fluids received by the channeling member 124 can pass through the opening 132 into the fluid collection chamber 111.

In some embodiments, the screening partition 130 can be fixedly attached to the collection assembly 120. In further embodiments, the collection assembly 120 and the screening partition 130 may be formed of a unitary piece of material. An outer edge of the screening partition 130 may tightly fit within the housing 110 and form a tight seal therewith in manners such as described above. In some embodiments, the spacers 146 ensure a desired spacing between the partition 130 and an upper surface of the cover 116.

Additional operation of the separation device 100 will now be described with further reference to FIG. 1B. The screen 122, the post 126, and/or the partition 130 can be configured to collect solids 74 from the disposal discharges 72 in manners such as described above. The upright orientation of the separation device 100, with the inlet 102 higher than the outlet 104, can permit gravity to aid in gathering the separated fluids 76 to the outlet 104.

In some instances, forces imparted to the discharge 72 by the disposal unit 60 and/or gravity can cause the discharge 72 to travel downwardly along the discharge channel 156. These forces can cause the separated solids 74 to collect at a bottom end of the screen 122 and be retained by the partition 130. In some embodiments, the solids 74 can fill the separation unit 110 from the bottom up. For example, in some embodiments, the screen 122 can be elongated in one or more directions that extend away from the inlet 102. In the illustrated embodiment, the screen 122 is elongated in a downward direction that extends away from the inlet 102. The compact, helical shape of the screen 122 and the constricted discharge channel 156 provide for a large surface area over which discharges from the garbage disposal unit 60 can be transported. The lower surface 155 of the channeling member 124, which forms the upper boundary of the constricted discharge channel 156, aids in redirecting or urging the discharges in the downward direction.

In various embodiment, solids 74 that are collected from early discharges are forced downwardly along the discharge channel 156 by subsequent discharges. For example, in some embodiments, a first discharge 72 may enter the separation unit 100 via the inlet 102. A first solids portion 74 from the first discharge 72 may collect on the screen 122 at a first position that is a first distance from the inlet 102. That distance may be measured as a distance along the discharge channel 156 or as a vertical distance from the inlet 102. The forces imparted by one or more subsequent discharges may displace the first solids portion 74 from the first position to a second position that is a second distance from the inlet 102. The second position can be a greater distance along the discharge channel 156, or a greater vertical distance, from the inlet 102. As previously mentioned, this pattern of filling the separation unit 100 can be repeated. Initially, solids portions 74 may be collected along the length of the screen 122. In other, or further embodiments, the collected solids portions 74 can ultimately fill the separation unit 110 from the bottom up.

The separation unit 100 can also be configured to permit fluids that drain through the garbage disposal unit 60 when the garbage disposal unit 60 is not activated to generally pass directly into the fluid channel 152 without first passing through previously collected solids portions 74. Such an arrangement can, in many instances, aid in dewatering or otherwise drying the solids portions 74. For example, in many arrangements, a garbage disposal unit 60 may only be used on occasion, whereas the drain 54 associated with that garbage disposal unit 60 may be used far more frequently to merely permit passage of water 70 and/or other fluids through the non-activated garbage disposal unit 60 and into the waste line 64. Accordingly, it may be advantageous to permit such water and/or other fluids that do not have not been provided with any momentum by the garbage disposal unit 60 to quickly pass into the fluid channel 152 without passing over or through previously collected solids portions 74. This can allow the solids portions 74 to dry and to remain dry for longer periods of time, and may also, in some instances, allow for a collection of a greater amount of organic material as the fluids may act as solvents, breaking down the solids portions 74 into smaller constituents, on a less frequent basis.

In the illustrated embodiment, when the garbage disposal unit 60 is not operating, the fluids 70 that pass through the drain and the garbage disposal unit 60 pass through the inlet 102 with a low velocity. Given their relatively small momentum, the fluids 70 only progress along the screen 122 a short distance before passing through the openings 144 into the fluid channel 152. The fluids 70 are then conducted in the fluid channel 152 into the fluid collection chamber 111 and through the outlet 104. The separation device 100 thus conducts the drained fluids 70 along a pathway that is separated from, or spaced from, the portion of the separation device 100 at which the solids portions 74 have been collected.

In some embodiments, the collected solids 74 can be removed from the housing 110 via the expulsion port 118. In particular, the cover 116 can be removed (e.g., manually pulled) from the housing 110 while the housing remains in its installed orientation. Stated otherwise, the expulsion port 118 can be used to remove the collected solids from the housing 110 while the housing remains coupled with the disposal unit 60 and the waste line 64 via the inlet 102 and the outlet 104, respectively. With the cover 116 removed, the partition 130 and the collection assembly 120 can be removed from the housing 120. In some embodiments, the cover 116, the partition 130, and the collection assembly 120 may be fixedly joined together such that the partition 130 and the collection assembly 120 are automatically removed from the housing 110 as the cover 116 is removed from the housing. The collected solids 74 can be cleared from the screen 122 in any suitable manner (e.g., via manual scooping, brushing, or otherwise) and collected for any desired use, such as composting. The collection assembly 120, the partition 130, and the cover 116 can then be returned to the housing 110 for further use of the separation device 100.

As previously discussed, in the embodiment depicted in FIGS. 1A-3, the expulsion port 118 is at the bottom end of the separation device 100. Accordingly, for some embodiments, it may be desirable to have a spacing beneath the installed separation device 100 that exceeds a height of the combined cover 116 and separation device 120 to permit ready removal of those items for cleaning while the housing 110 remains attached to the conduit 62 and the waste line 64. In other embodiments, the bottom end of the separation device 100 may be relatively close to a floor of a cupboard or other area in which the separation device 100 is installed. In certain of such scenarios, it may be desirable for the expulsion port 118 and the cover 116 to be positioned at the top end of the separation device 100, and thus the separation device 120 may be removed through the top end of the housing 110. For example, with reference to FIG. 2, the bottom end of the housing 110 may be permanently closed, and spacers 146 may be suitably mounted to space the screening partition 130 from the closed end of the housing 110. The upper end of the housing 110 can define the opening 114, and the cover 116 can be removably coupled to the upper end of the housing 110. In some embodiments, the waste line 64 may be installed within the structure (house, apartment, etc.) so as to extend downwardly through the floor of the cabinet or cupboard. Such an arrangement may provide for additional space at either an upper or lower end of the separation device 100 for removal of the collection assembly 120. In still other or further embodiments, the housing 110 and/or the inlet 102 and outlet 104 can be readily decoupled from the conduit 62 and the waste line 64 in order to open the expulsion port 118 and clean out the collected solids from the collection assembly 120.

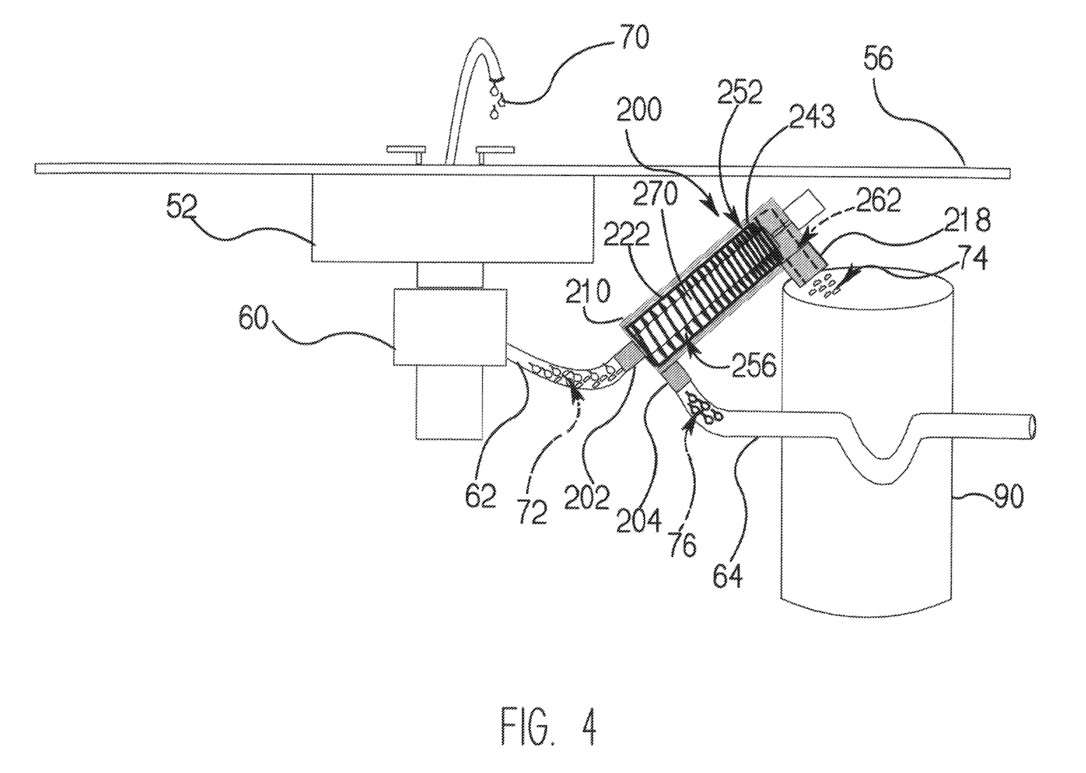

FIG. 4 depicts another embodiment of a separation device 200 that is installed in an environment such as that described above with respect to the separation device 100. The separation device 200 resembles the separation device 100 described above in certain respects. Accordingly, like features are designated with like reference numerals, with the leading digits incremented to “2.” Relevant disclosure set forth above regarding similarly identified features thus may not be repeated hereafter. Moreover, specific features of the separation device 200 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the separation device 200. Any suitable combination of the features and variations of the same described with respect to the separation device 100 can be employed with the separation device 200, and vice versa. This pattern of disclosure applies equally to further embodiments depicted in subsequent figures and described hereafter, wherein the leading digits may be further incremented.

In the illustrated embodiment, the separation device 200 includes a housing 210, an inlet 202, an outlet 204, and an expulsion port 218. The housing 210 is elongated in a longitudinal direction and defines a longitudinal axis. In some embodiments, the inlet 202 is aligned with the longitudinal axis, as in the illustrated embodiment, whereas in other embodiments, the inlet 202 may be offset from the longitudinal axis. When installed, the outlet 204 can be at a lower end of the separation device 200 and the expulsion port 218 can be at an upper end of the separation device 200. As further discussed below, the separation device 200 can include a transporter 270 that is configured to move separated solids 74 upwardly through the housing 210 and out of the expulsion port 218. The expelled solids 74 may be collected in a receptacle 90 or in any other suitable manner.

With reference to FIG. 5, the housing 210 can define a cavity 219. Positioned within the cavity can be one or more sealing members 242, 243, such as O-rings. In the illustrated embodiment, a first sealing member 242 is positioned at the lower end of the housing 210 and a second sealing member 243 is positioned at an upper end of the housing 210. The sealing members 242, 243 can be configured to form a fluid-tight seal with an exterior surface of a screen 222. The housing 210 can further define an opening 279 through which an upper end of the screen 222 can pass when the screen 222 is fully inserted into the cavity 219.

The screen 222 can define a collection chamber 259 that is particularly suited for the collection of solids 74. The screen 222 can define a plurality of openings 244 through which fluid can be permitted to pass from an interior of the screen 222 to an exterior of the screen 222. In particular, the screen 222 can permit the fluid to pass from within the collection chamber 259 into a fluid channel 252 between an inner surface of the housing 210 and an outer surface of the screen 222. As shown in FIG. 4, the fluid channel 252 can extend longitudinally between the sealing member 242, 243, and can be in fluid communication with the outlet 204.

The separation device 200 can further include a transporter 270 that is configured to be received within the collection chamber 259 of the screen 222. In some embodiments, the transporter 270 comprises a central post 272 that is encompassed by an inclined plane 274. The inclined plane 274 defines opposing surfaces 276, 278 that face one another. In the illustrated embodiment, the spacing between the opposing surfaces 276, 278 decreases from the lower end to the upper end of the transporter 270. The opposing surfaces 276, 278 of the inclined plane 274, the post 272, and the screen 222 define a discharge channel 256, as shown in FIG. 4.

The separation device 200 can further include a cap 260 that is configured to be coupled with the housing 210. The cap 260 can define an expulsion passageway 262 through which solids can be passed from the discharge channel 256 to the expulsion port 218. In the illustrated embodiment, the expulsion passageway 262 is sized to receive an upper end of the screen 222 and the transporter 270. Accordingly, in operation, the transporter 270 can urge collected solids upwardly over a top edge of the screen 222 into the expulsion passageway 262 and then outwardly through the expulsion port 218. In some embodiments, the sealing member 243 can prevent the solids portions from being transferred from the expulsion passageway 262 into the fluid channel 252. In various embodiments, the cap 260 defines at least a portion of the expulsion port 218, or the expulsion port 218 may be a separate piece that is attached to the cap 260 and that defines a pathway through which the transporter 270 can urge solids from the separation device 200.

A torque-generating device 280 can be coupled with the transporter 270 in any suitable manner. In the illustrated embodiment, the torque-generating device 280 includes a shaft 282 that passes through the cap 260 and attaches to the post 272 of the transporter 270. The torque-generating device 280 can be configured to rotate the shaft 282 and thereby rotate the transporter 270—in particular, the torque-generating device 280 can be configured to rotate the inclined plane 274. The torque-generating device 280 can be of any suitable variety, such as a mechanically, electrically, and/or hydraulically driven device. For example, the torque-generating device can comprise one of a hand crank, an electrical motor, or a hydraulic torque wrench. In some embodiments, the torque-generating device 280 may be operated manually, such as by rotating the hand crank or by holding down a button. In other embodiments, the torque-generating device 280 can operate automatically. For example, in some embodiments, the torque generating device 280 can be configured to rotate the transporter 270 on a set schedule (e.g., at one or more times during a day or week). In other or further embodiments, the torque-generating device 280 can be configured to rotate the transporter 270 in conjunction with operation of the disposal unit 60. For example, the torque-generating device 280 may be electrically coupled with the controls for the disposal unit 60 and can be configured to rotate the transporter 270 by a certain amount (e.g., by 1, 2, 3, 4, 5, 10, 15, or 20 or more revolutions) after a predetermined amount of time (e.g., 30 seconds, 1 minute, 2 minutes) has passed after operation of the disposal unit 60. The time may be selected to be an amount sufficient to permit liquid to have been separated from the discharge 72 and drained via the waste line 64. The separation device 200 thus may be configured to either manually or automatically expel the collected solids 74.

As can be seen in FIG. 4, in the illustrated embodiment, the screen 222 is elongated in a direction that extends away from the inlet 202. In particular, the screen 222 is elongated along the longitudinal axis of the separation device 200. When the separation device 200 is installed in the fixed position shown in FIG. 4, the screen 222 may be said to extend upwardly and outwardly away from the inlet 202. Or, stated otherwise, the screen 222 extends away from the inlet 202 in two directions (e.g., in a single direction having a vertical component and a horizontal component). The screen 222 thus extends away from the inlet 202 in at least one direction, one of which is upward.

With continued reference to FIG. 4, the separation device 200 includes two separate and distinct pathways: the discharge channel 256 and the fluid channel 252. The discharge channel 256 receives, via the inlet 202, discharges 72 at relatively high velocity from the disposal unit 60 when the disposal unit 60 is activated, and likewise receives at relatively low velocity fluid 70 (e.g. water) that has drained through the disposal unit 60 when the disposal unit 60 is non-activated. An opening of the inlet 202 can be positioned relative to the transporter 270 in a manner that permits the discharge 72 and the low velocity fluid 70 to enter the discharge channel 256. For example, in some embodiments, a bottom end of the post 276 may be aligned with the opening of the inlet 202 but may be spaced from the opening such that discharges 72 can initially contact the bottom end of the post 276 as they are forced upwardly through the discharge channel 256. In other embodiments, the bottom end of the post 276 may be offset from the opening of the inlet 202.

A first discharge 72 can be forced upwardly along the discharge channel 256 due to the high momentum (e.g., upward momentum) at which it enters the separation device 200. A first solids portion 74 of the first discharge 72 can come to a rest at a first position within the discharge channel 256. For example, the solids portion 74 may rest against the screen 222, the opposing surfaces 276, 278 of the inclined plane, and/or the post 272. The fluid portion 76 of the discharge 72 can pass through the screen 222 into the fluid channel 252. Gravity can pull the fluid portion 76 downwardly through the fluid channel 252 through the outlet 204 and into the waste line 64.

The first position at which the solids portion 74 comes to rest may be spaced away from the inlet 202 by an amount sufficient to permit fluids 70 that subsequently drain through the non-activated disposal unit 60 to trickle through the lower end of the separation device 200 without passing through any portion of the previously collected solids portion 74. For example, the subsequently drained fluids 70 may enter the housing 200 via the inlet 202 with a low momentum, such that the fluids move upwardly through the discharge channel 256 by only a small amount before passing through the screen 222 into the fluid channel 252 and then out through the outlet 204 into the waste line 64.

A second discharge 72 that takes place after the first solids portion 74 described above has come to rest within the discharge channel 256 can displace the solids portion 74 from the first position and move the solids portion 74 upwardly away from the inlet 202 by a greater amount. The solids portion 74, and an additional solids portion that is separated from the second discharge 72, may then come to rest within the discharge channel 256 and a fluid portion 76 from the second discharge 72 can drain from the discharge channel 256 through the screen 222 into the fluid channel 252 and then outwardly through the outlet 204.

After one or more solids portions 74 have been collected in the discharge channel 256, the transporter 270 can be rotated to urge the solids portions 74 upwardly toward the expulsion passageway 262 and then outwardly through the expulsion port 218. As previously mentioned, the solids 74 that pass through the expulsion port 218 can be collected in a receptacle 90 of any suitable variety. As can be appreciated from the foregoing, in some embodiments, the solids 74 can be expelled from the separation device 200 without any portion of the separation device 200 being disassembled to provide access to the cavity 219 of the housing 210.

In the illustrated embodiment, the transporter 70 is configured to squeeze excess fluid from the solids portion 74 as the solids portion 74 is advanced upwardly toward the expulsion port 218. In particular, due to the increasingly narrow spacing between the opposing faces 276, 278 of the inclined plane 272, the solids portion 74 is compressed as it is advanced toward the expulsion port 218, which can urge a greater amount of fluid from the solids portion 74 through the screen 222.

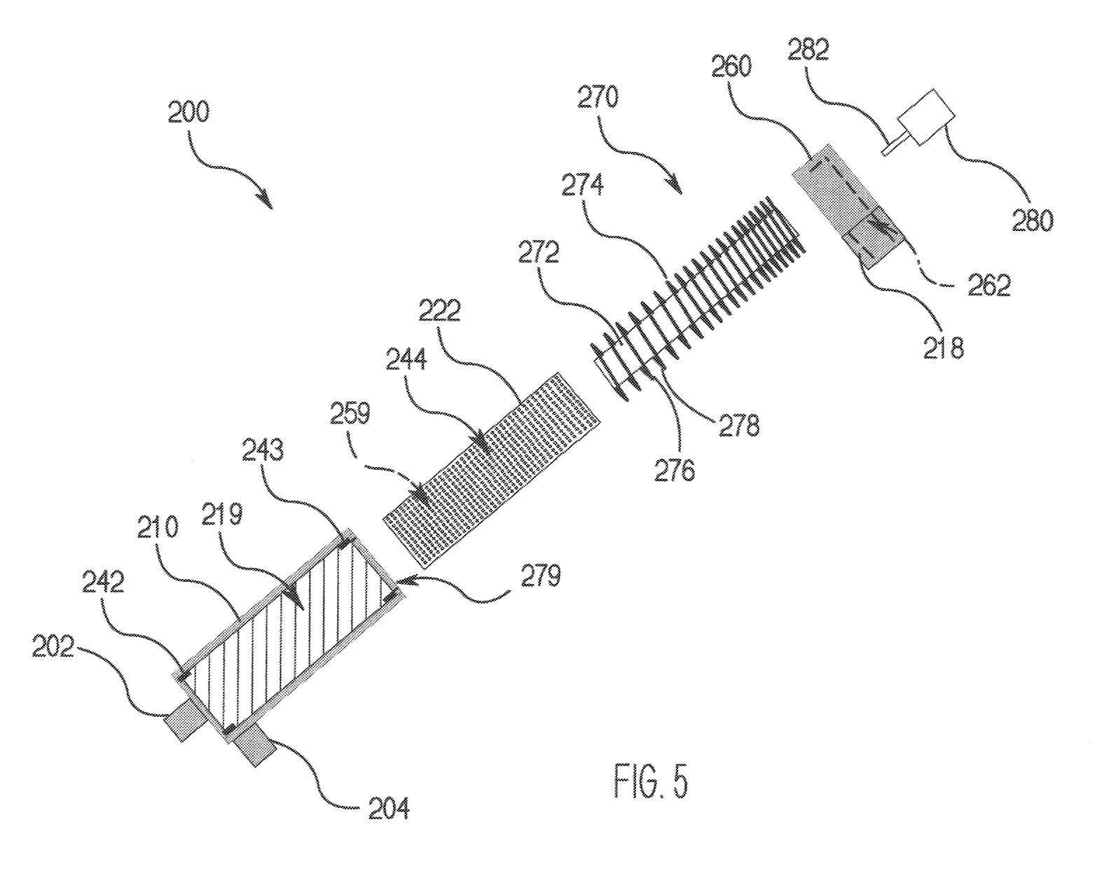

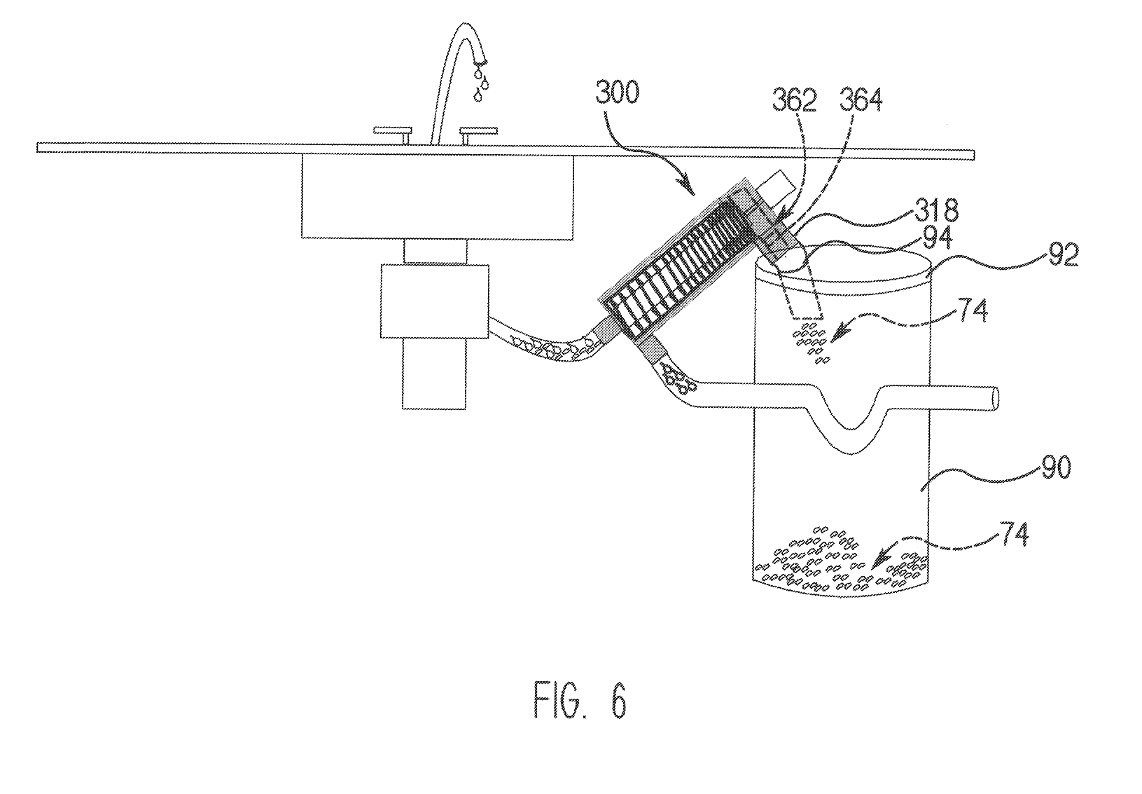

FIG. 6 depicts another embodiment of a separation device 300 that is installed in an environment such as that described above with respect to the separation devices 100, 200. The separation device 300 resembles the separation devices 100, 200 described above in certain respects, and particularly resembles the separation device 200. However, the separation device 300 includes an expulsion port 318 that differs from the expulsion port 218. In particular, the expulsion port 318 is configured to selectively communicate with an expulsion passageway 362 (such as the expulsion passageway 262 described above) via a valve 364. The valve 364 may be of any suitable variety, such as a mechanical valve (e.g., check valve), an electrically operated valve (e.g., solenoid valve), or a hydraulically operated valve. The valve 364 can be selectively opened to permit the passage of solids 74 through the expulsion port 318. When the valve 364 is closed, it can prevent solids 74 and/or odors associated therewith from passing through the expulsion port 318.

In some embodiments, the expulsion port 318 can include a tube 94 or other suitable conduit that can extend through a removable lid 92 that is selectively coupled with the receptacle 90. Such an arrangement can be used to contain odors associated with the collected solids 74. The receptacle 90 may be positioned in an under-sink environment.

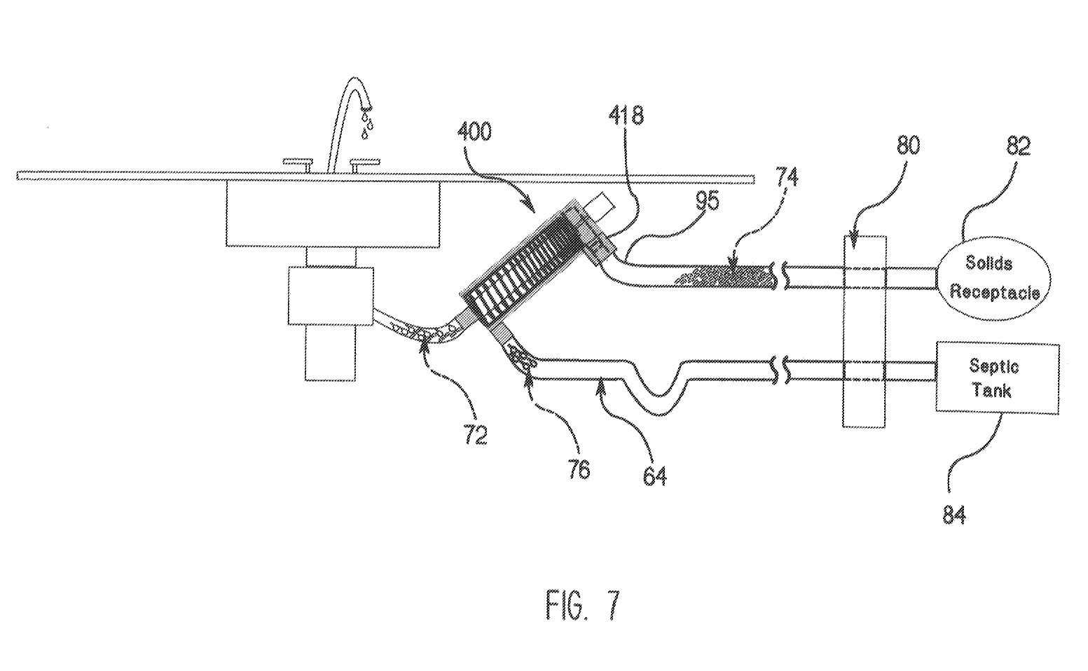

FIG. 7 depicts another embodiment of a separation device 400 that is installed in an environment such as that described above with respect to the separation devices 100, 200, 300. The separation device 400 resembles the separation devices 100, 200, 300 described above in certain respects, and particularly resembles the separation device 300. However, the separation device 400 includes an expulsion port 418 that is connected to a solids conduit 95 that extends through a wall 80 or other barrier of a structure within which the separation device 400 is installed to a solids receptacle 82 that is at an exterior of the structure. The solids 74 that are separated from discharges 72 thus can be collected at an exterior of the structure. FIG. 7 also illustrates that fluids 76 separated from the discharges 72 can be passed through a waste line 64, through the wall 80 or barrier of the structure, and to a septic tank 84. In other embodiments, the fluids 76 may instead be delivered to a sewer system.

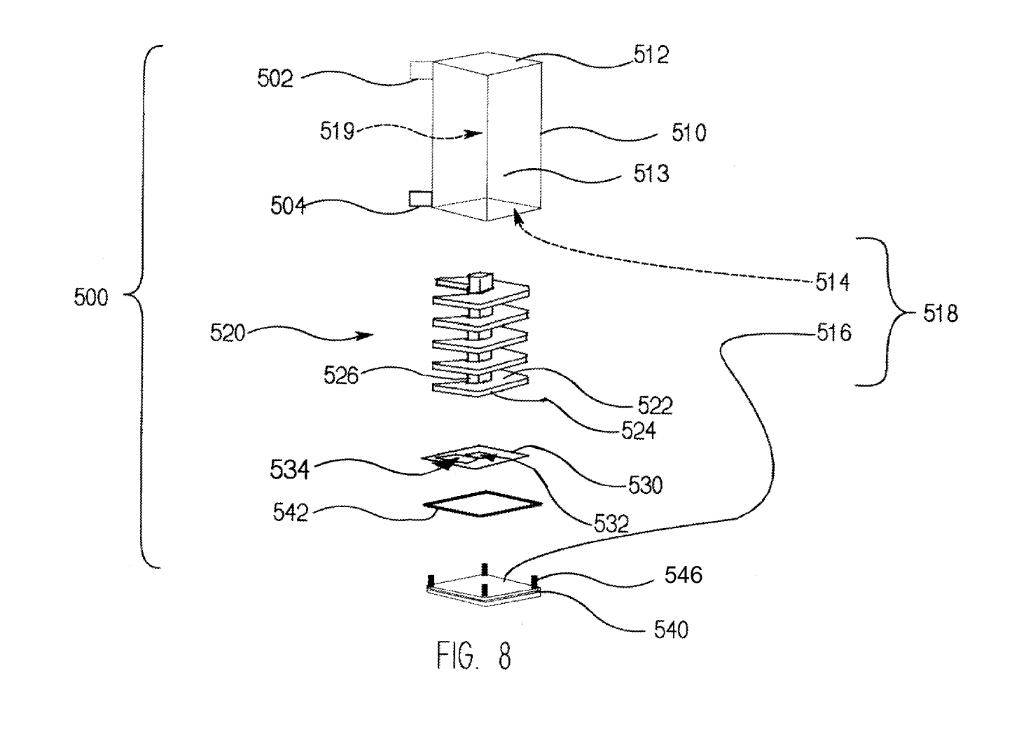

FIG. 8 depicts another embodiment of a separation device 500 that resembles the separation devices discussed above. In the illustrated embodiment, the separation device 500 is most similar to the separation device 100, except that the separation device 500 has a generally box-shaped rectangular or square configuration, rather than the generally cylindrical configuration of the separation device 100. In particular, one or more components of the separation device 500 can have a rectangular (e.g., square) cross-section or outer profile, whereas one or more components of the separation device 100 discussed above can have a circular cross-section or outer profile (or, in other embodiments, may have an elliptical, oval, or other generally rounded cross-section or outer profile).

As can be seen in FIG. 8, various components of the separation device 500 can have a square outer profile. Such components can include one or more of a housing 510 (including one or more of an upper wall 512, a side wall 513, and a lower opening 514 thereof), a cavity 519 defined by the housing, a cover 516 that is configured to couple with the housing 510, a groove 540 defined by the cover 516, a sealing element 542, a screening partition 530 (including one or more openings 532, 534 defined thereby), and a collection assembly 520 (including a channeling member 124, one or more angled screens 522, and a central post 526 thereof). As with the separation device 100, the separation device 500 can include an expulsion port 518, an inlet 502, and an outlet 504. The cover 540 may include spacers 546.

In some embodiments, an outer profile of the collection assembly 520 can closely fit an inner profile of the housing 510. For example, in some embodiments, the outer profile of the collection assembly 520 can form a fluid tight seal with the inner profile of the housing 510.

In certain embodiments, the separation device 500 can more closely resemble the separation device 200 described above. For example, one or more of the components of the separation device 200 can be shaped substantially as a rectangle (e.g., as a square).

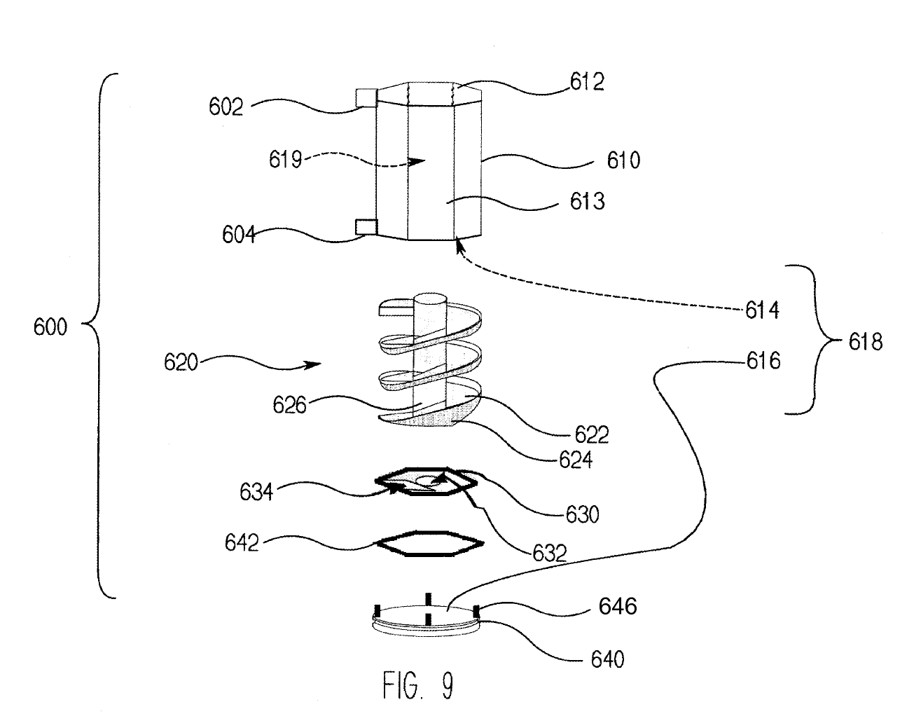

FIG. 9 depicts another embodiment of a separation device 600 that resembles the separation devices discussed above. In the illustrated embodiment, the separation device 600 is most similar to the separation device 100, except that the separation device 600 has a generally hexagonal configuration, rather than the generally cylindrical configuration of the separation device 100. In particular, one or more components of the separation device 600 can have a hexagonal cross-section or outer profile, whereas one or more components of the separation device 100 discussed above can have a circular cross-section or outer profile (or, in other embodiments, may have an elliptical, oval, or other generally rounded cross-section or outer profile).

As can be seen in FIG. 9, various components of the separation device 600 can have the hexagonal outer profile. Such components can include one or more of a housing 610 (including one or more of an upper wall 612, a side wall 613, and a lower opening 614 thereof), a cavity 619 defined by the housing, a cover 616 that is configured to couple with the housing 610, a groove 640 defined by the cover 616, a sealing element 642, a screening partition 630 (including one or more openings 632, 634 defined thereby), and a collection assembly 620 (including a channeling member 124, one or more angled screens 622, and a central post 626 thereof). As with the separation device 100, the separation device 600 can include an expulsion port 618, an inlet 602, and an outlet 604. The cover 640 may include spacers 646.

In some embodiments, an outer profile of the collection assembly 620 can closely fit an inner profile of the housing 610. For example, in some embodiments, the outer profile of the collection assembly 620 can form a fluid tight seal with the inner profile of the housing 610.

In certain embodiments, the separation device 600 can more closely resemble the separation device 200 described above. For example, one or more of the components of the separation device 200 can be shaped substantially as a hexagon.

Any other suitable shapes or profiles are contemplated for the separation devices. In some embodiments, the shape of one or more components may be selected to facilitate, accelerate, and/or reduce the cost of manufacture of the separation device. Further, some embodiments can include more or fewer components than those shown in the drawings and described above. For example, in some embodiments, the collection assemblies 120, 520, 620 may be devoid of dedicated channeling members 124, 524, 624. In certain of such embodiments, one or more screens 122, 522, 622 may be used to separate solids portions from fluid, and the fluid may drain to other portions of the screens 122, 522, 622. For example, in some embodiments, the separated fluid may drain to other portions of the screens without first contacting other portions of the collection assemblies 120, 520, 620 and/or by passing through a portion of the housing (with or without contacting an inner wall of the housing).

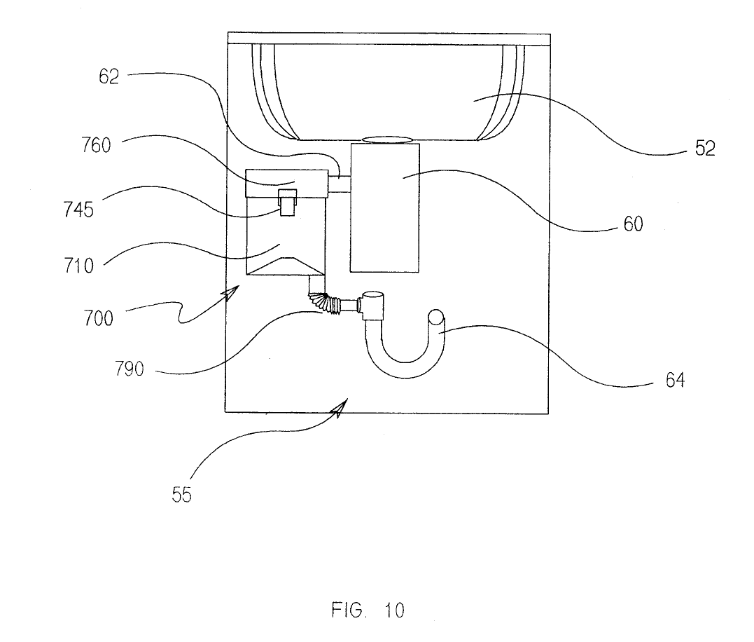

FIG. 10 depicts another embodiment of a separation device 700. The separation device 700 is installed under a sink 52. In the particular arrangement shown in FIG. 10, the separation device is coupled with a disposal unit 60 that is positioned so as to receive food waste directly from the sink 52. The separation device 700 is coupled with a discharge port of the disposal unit 60 via a conduit 62.

The illustrated embodiment of the separation device 700 comprises a lid or cap 760. In the illustrated arrangement, the cap 760 is fixedly or securely mounted to the conduit 62 so as to be stationary relative thereto. The separation device 700 further comprises a containment unit or housing 710 that can be selectively coupled to and decoupled from the cap 760. In the illustrated embodiment the cap 760 and the housing 710 can be selectively coupled to each other via one or more fastening mechanisms, such as a latch 745. The housing 710 is coupled with a flexible discharge conduit 790, which is coupled with the waste line 64. The flexible discharge conduit 790 can comprise any suitable device, such as a flexible pipe, a flexible tube, etc. In use, the separation device 700 can be in a connected state in which the cap 760 is connected to the housing 710. The separation device 700 can gather solids portions from one or more discharges from the garbage grinder 60. The separation device 700 can be transitioned to a disconnected state to remove the solids portions that have gathered over time. In the illustrated embodiment, the latch 745 can be decoupled to permit the housing 710 to be separated from the cap 760. The housing 710 can then be moved to a more suitable orientation that is spaced away from the cap 760 in order to access an upper opening, or discharge port, of the housing 710. The flexible discharge conduit 790 can permit relatively free movement of the housing 710 in this manner. For example, the end of the conduit 790 that is coupled to the waste line 64 may be fixed or stationary relative to the waste line 64, but the end that is coupled to the housing 710 may be moveable relative to the waste line 64. In some embodiments, the housing 710 may be turned upside down, or by some other rotated angle, while the housing 710 remains fluidly coupled with the waste line 64 via the discharge conduit 790.

FIG. 11 depicts the separation unit 720 in greater detail. The cap 760 can include an inlet 702, which can be coupled to the conduit 62, as discussed above. In some embodiments, the cap 760 further comprises a baffle 766 that is positioned so as to disrupt a discharge that enters the separation device 700 via the inlet 702. In some embodiments, the cap 760 further comprises a portion of the latch 745. In the illustrated embodiment, the cap 760 comprises a catch 768 that is configured to interact with a hook 747 portion that is attached to the housing 710. In other embodiments, the cap 760 can include the hook 747 and the housing 710 can include the catch 768. The illustrated latch 745 is an over-the-center latch. However, any other suitable fastening mechanism is contemplated.

In some embodiments, the separation unit 720 includes a sealing member 742, which can assist in creating a fluid-tight seal between the housing 710 and the cap 760. In other embodiments, the sealing member 742 may be omitted.

In the illustrated embodiment, a screen 722 is positioned within a cavity of the housing 710. In some embodiments, the screen 722 is permanently attached to the housing 710. In other embodiments, the screen 722 can be selectively removable from the housing 710. (For example, in some embodiments, the screen 722 can include a handle—not shown—to aid in selectively removing the screen 722 from the housing 710). In some embodiments, the screen 722 includes a sloping configuration. In the illustrated embodiment, the screen slopes downwardly toward the outer edge thereof. The illustrated shape is substantially conical, or substantially frustoconical. The screen 722 can be positioned at the bottom of the housing 710, as depicted in FIG. 10. Solids portions can thus be collected above the screen 722 within the housing 710.

As previously mentioned, the housing 710 can define a discharge port or expulsion port 718 through which solids portions can be removed from the housing 710. The housing 710 further includes an outlet 704 through which fluids that pass through the screen 722 can pass from the separation device 700.

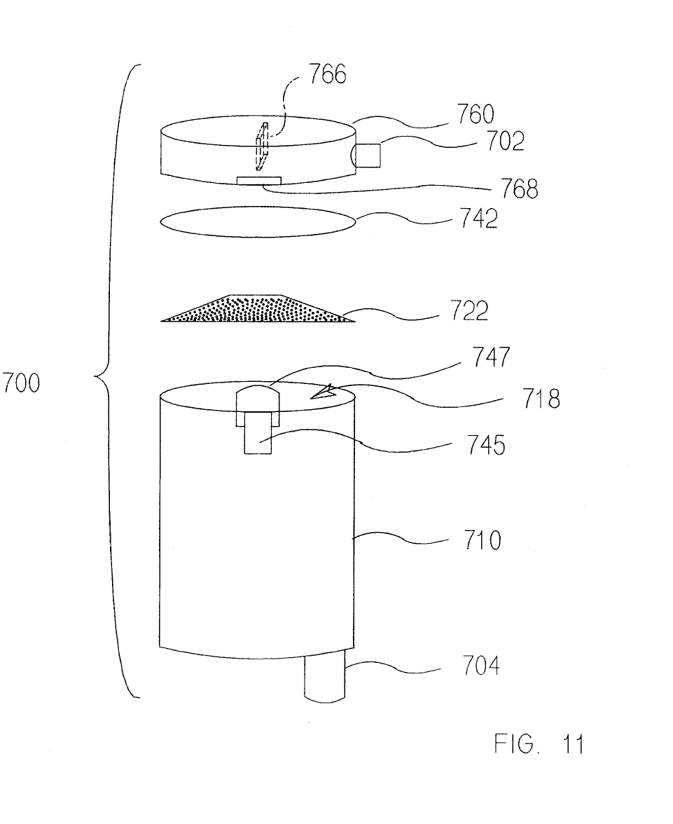

With reference to FIG. 12, in some embodiments, the solids portions that are removed from the housing 710 via the expulsion port 718 can be introduced into or collected in a receptacle 91. The receptacle 91 may be of any suitable variety. For example, in some embodiments, the receptacle 91 is a bag of any suitable variety. In further embodiments, the bag may be specially designed for use in composting (e.g., the bag 91 may be a composting bag). In other embodiments, the receptacle 91 may be a food waste recycling bin or recycling container, such as, for example, a variety that may be provided by a municipality.

As depicted by the arrow in FIG. 12, the solids portions may be manually removed from the housing 710 for introduction into the receptacle 91. However, in other embodiments, such as discussed below, the separation device may be configured to automatically introduce the collected solids portions into the receptacle 91.

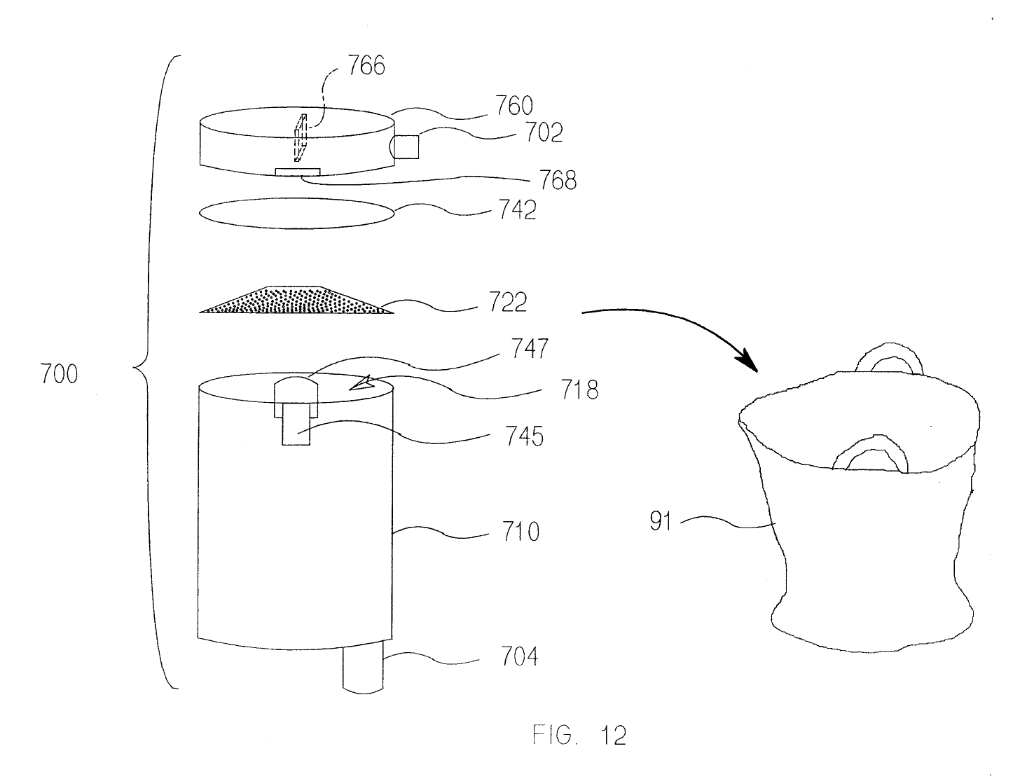

FIG. 13 illustrates another embodiment of the separation device 700. In some embodiments, the separation device 700 is identical to the device described above, with the only exception being that the device 700 receives input directly from the sink 52 without a garbage disposal as an intermediary. For example, the solids portions that are collected by the separation device 700 can comprise unground food waste. In other embodiments, in addition to an altered installation arrangement in which the separation device 700 receives solids portions directly from the sink 52, the device 700 may be altered in ways that may facilitate introduction of the food waste into the separation device 700. For example, the inlet 702 discussed above, may be positioned at an upper end of the cap 760, rather than at a side thereof. Additionally, in some arrangements, an opening of the inlet 702 may be relatively larger than that depicted in FIG. 11.

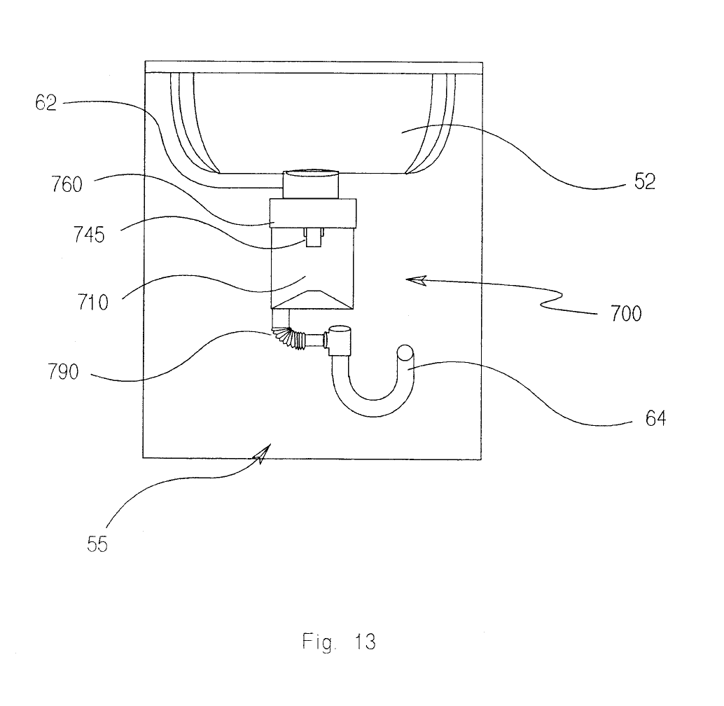

FIGS. 14-19 depict various embodiments of separation devices that are elongated along an axis. In some embodiments, the axis along with the separation devices is elongated can be substantially aligned with the momentum of the discharge provided as it exits a sink or provided by operation of a garbage grinder. In some embodiments, the momentum of the discharge (such as may be provided by a garbage grinder) is used as the motive force to advance solids portions through the separation device and ultimately through an expulsion port. In other or further embodiments, motors or other suitable mechanisms may be used to assist in movement of the solids portions through the separation device and ultimately through the expulsion port.

As depicted in FIG. 14, in some embodiments, a separation device 800 can include an inlet 802, a housing 810, an outlet 804, a screen 822, and an expulsion port 818. As with other embodiments discussed herein, the screen 822 can be rigid or flexible. In the illustrated embodiment, the separation device 800 further comprises a liquid collection chamber 825, which may comprise any suitable device (e.g., a vessel, tube, conduit, container) having any suitable shape or dimensions. The liquid collection chamber 825 is positioned to receive separated liquids portions from the screen 822 and to deliver them to the outlet 804.

The separation device 800 can include one or more separation components that aid in separating the solids portions from the liquids portions of discharges from a sink or garbage grinder. In the illustrated embodiment, the separation components are star wheels, or star-shaped rotational blades or paddles 871. Any suitable devices may be used for the separation components, such as, for example, one or more rotary discs, wheels, drums, belts, and/or baffles, which may comprise various materials and/or have varying degrees of flexibility, as desired.

In operation, a discharge, or constituent fluid having a solids portion and a liquid portion, enters the separation device via the inlet 802. Striking a stationary or slower moving object can facilitate separation from the solids portion from the liquid portion (or “working fluid”). In some instances, water can be a heavier or denser material and may yield more readily to the gravitational force than the solids portion, and may pass downwardly through the screen 822, which may also be referred to as a separation membrane. As the solids portions can be larger than the membrane openings, they can remain above the separation membrane on a path or passageway to the outlet 804. In the illustrated embodiment, the passageway is substantially linear and extends in a substantially horizontal orientation.

The solids portions that are collected in the housing 810 above the screen 822 can be moved toward the expulsion port 818. In some embodiments, the momentum of subsequent discharges that enter the inlet 802 is sufficient to push collected solids portions through the housing 810 and eventually through the expulsion port 818. In other or further embodiments, one or more of the separation elements, or rotational paddles 871, can be configured to move the solids portion through the housing 810.

For example, in some embodiments, the separation components may be used to transport the solids portion to the expulsion port 818. For example, in some embodiments, the rotational paddles 871 may be powered in any suitable manner (e.g., via an electrical motor, hand crank, etc.) to move the solids portions through the separation device 800. Stated otherwise, the separation device 800 can comprise a transporter 870, which can include one or more of the rotational paddles 871.

The illustrated embodiment of the separation device 800 includes four rotation paddles 871. More or fewer paddles are contemplated. Additionally, as discussed further below, one or more paddles may be combined in any suitable manner with other separation and/or transport features.

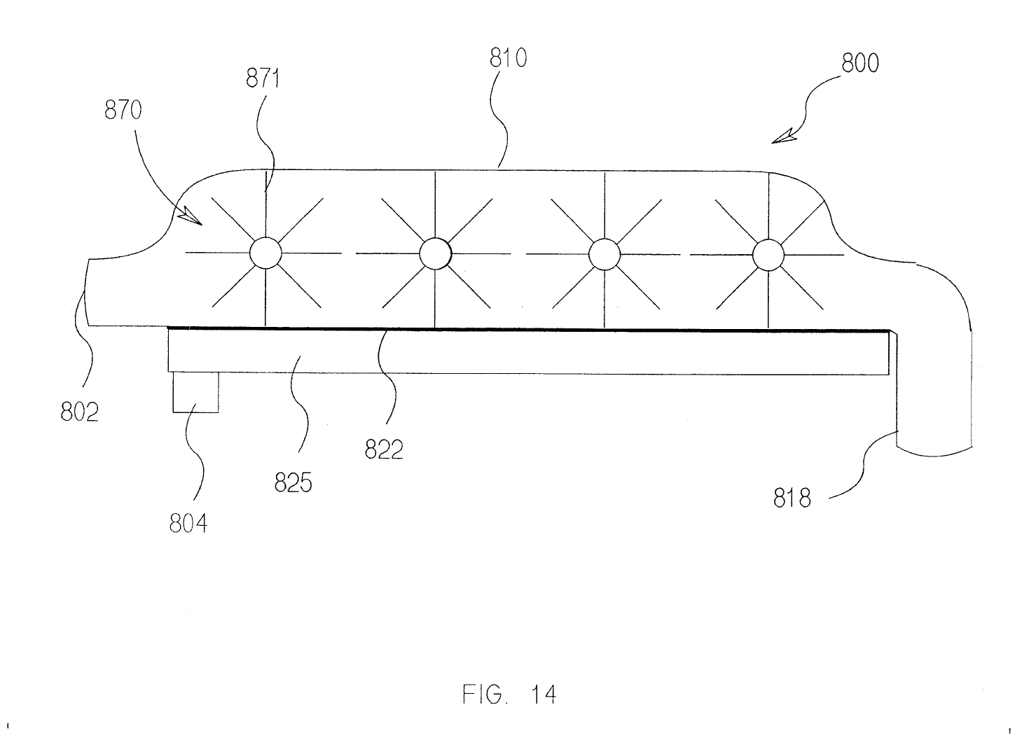

FIG. 15 depicts another embodiment of a separation device 900 that includes an inlet 902, a housing 910, an outlet 904, a screen 922, an expulsion port 918, and a liquid collection chamber 925. The separation device 900 can include one or more separation components that aid in separating the solids portions from the liquids portions of discharges from a sink or garbage grinder. In the illustrated embodiment, the separation components comprise baffles 973. In some embodiments, the baffles may have varying degrees of flexibility. For example, the illustrated baffles 973 are stiffer at their upper ends and more flexible at their lower ends. The baffles 973 can resist passage thereby of discharges, which can aid in separation of the constituent components of the discharge.

In some embodiments, the baffles 973 may be used to urge solids through the housing 910. In various embodiments, the baffles may be electrically driven. The baffles 973 can function as a transporter 970 in certain of such embodiments.

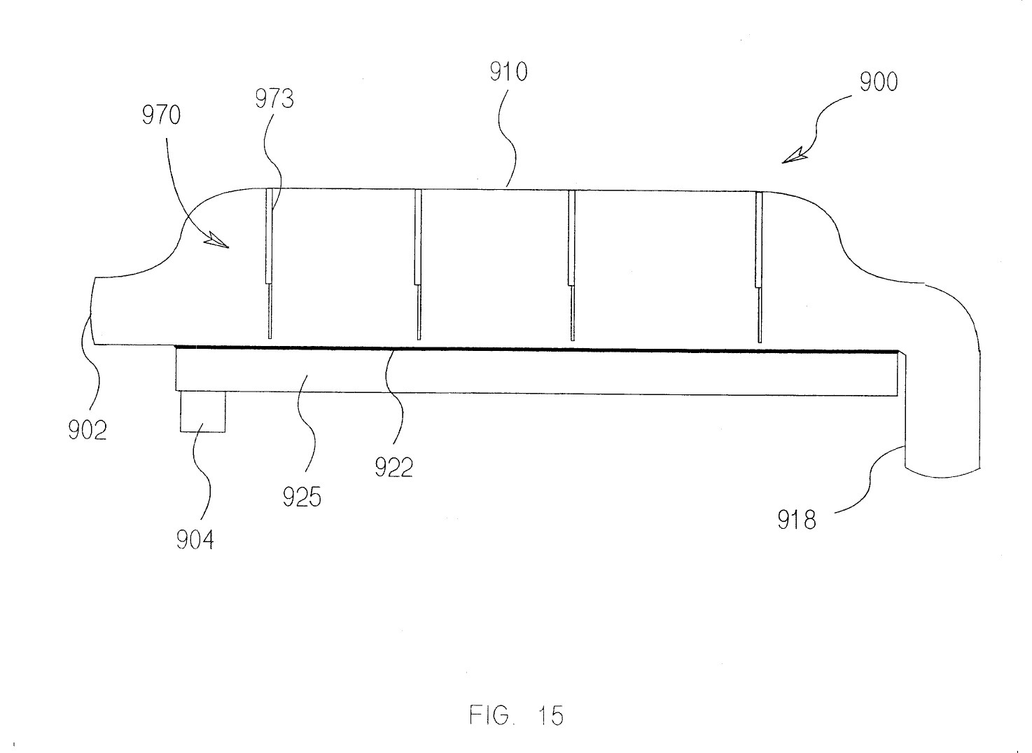

FIG. 16 depicts another embodiment of a separation device 1000 that includes an inlet 1002, a housing 1010, an outlet 1004, a screen 1022, an expulsion port 1018, and a liquid collection chamber 1025. The separation device 1000 can include different varieties of separation components that aid in separating the solids portions from the liquids portions of discharges from a sink or garbage grinder. In the illustrated embodiment, the separation components comprise two rotational paddles 1071 and two baffles 1073, such as similarly numbered components described above. In various embodiments, more or fewer paddles 1071 and/or baffles 1073 can be used. The separation and/or transportation elements can be ordered in any suitable manner as well. For example, in the illustrated embodiment, the rotation paddles 1071 precede the baffles 1073, whereas in other embodiments, this order can be reversed and/or interspersed.

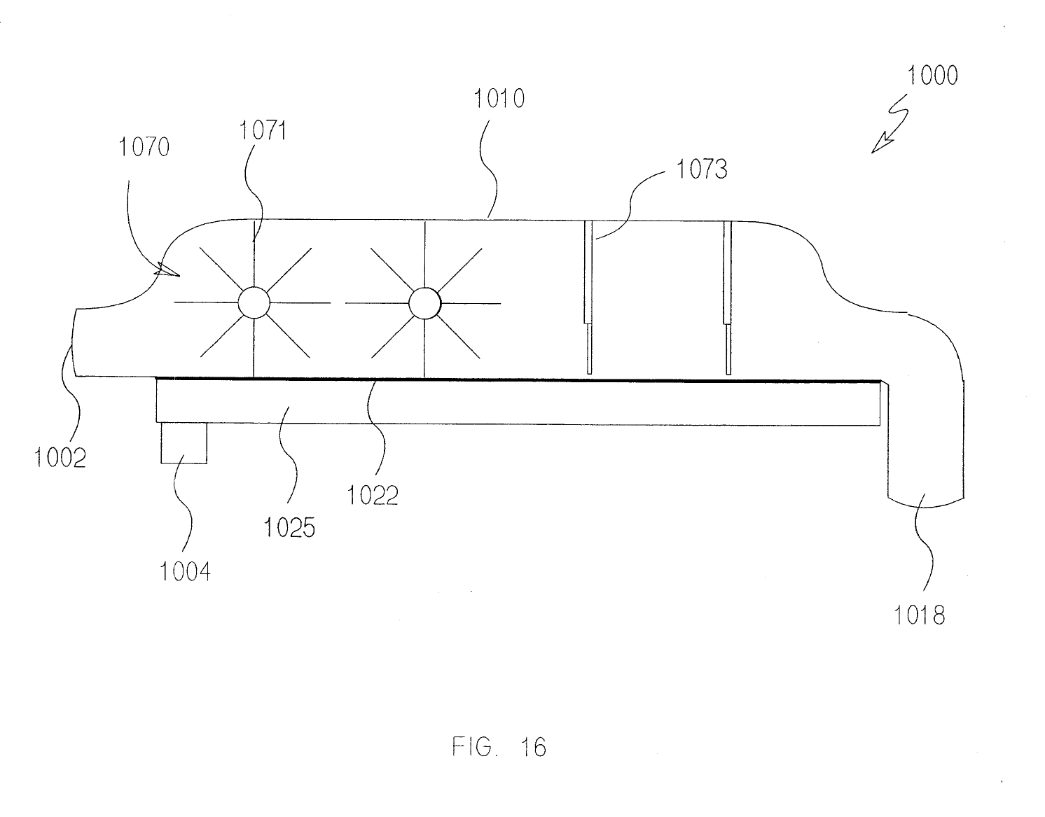

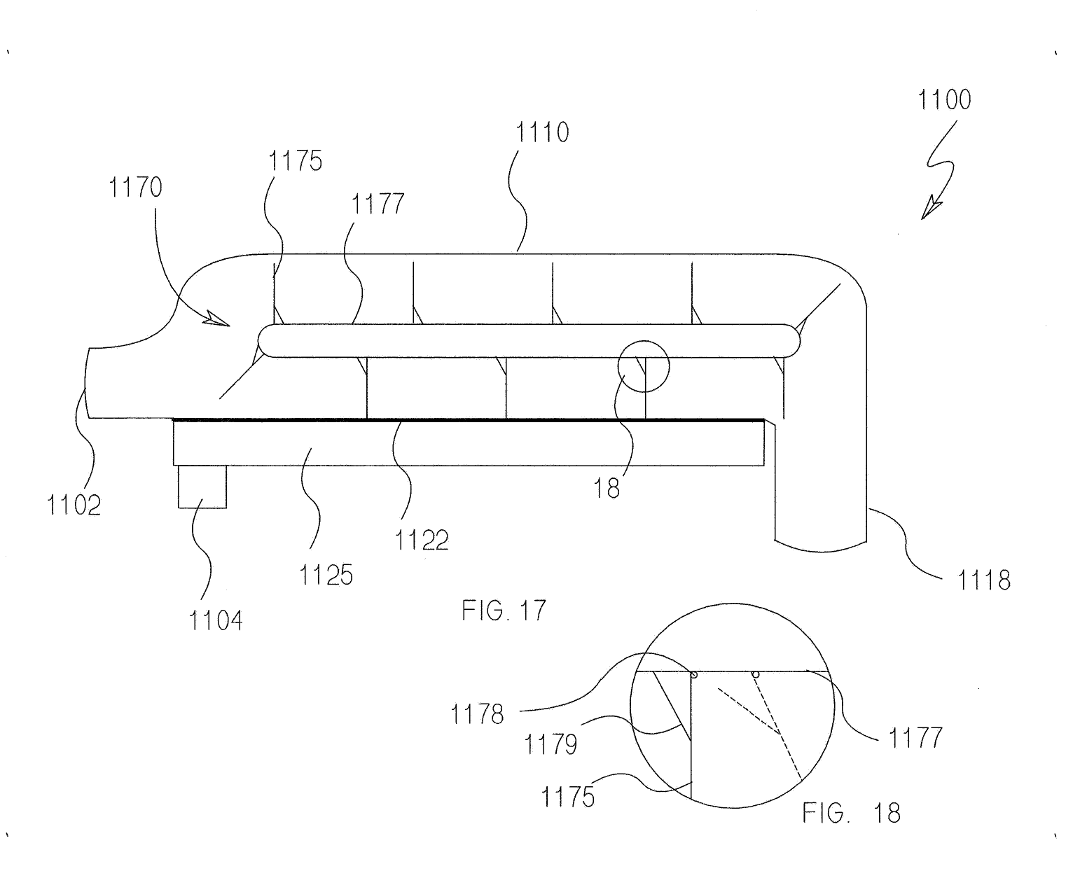

FIG. 17 depicts another embodiment of a separation device 1100 that includes an inlet 1102, a housing 1110, an outlet 1104, a screen 1122, an expulsion port 1118, and a liquid collection chamber 1125. The separation device 1100 can include one or more separation and/or transportation components that aid in separating the solids portions from the liquids portions of discharges from a sink or garbage grinder. In the illustrated embodiment, the separation device 1100 includes a belt 1177 with flights 1175. In various embodiments, the belt 1177 and flights 1175 can be manually and/or electrically powered to rotate (e.g. in a counterclockwise direction) to urge the solids portions through the housing 1110 and through the expulsion port 1118. In some embodiments, the momentum of the effluent may assist in moving the solids through the housing 1110 and/or may provide or contribute to the motive force for the belt 1177 and flights 1175.

FIG. 18 depicts an enlarged view of another embodiment of the separation device 1100 in which the flights 1175 are hinged at their respective attachment points in a manner that allows the flights to swing in only a single direction. The flights 1175 may be biased or otherwise naturally return to a non-displaced orientation. Accordingly, in some embodiments, when effluent or discharge that enters via the inlet 1102 has a greater velocity than the velocity at which the belt 1177 is moving the flights 1175, the flights 1175 can act as baffles that yield to the discharge. This can aid in separation of the constituent components of the discharge in manners such as described above. Upon sufficient slowing or settling of the solids portions, the flights 1175 can act more as pushing or transport elements that urge the solids along the screen 1122 and eventually through the expulsion port 1118 to evacuate the housing 1110. Stated otherwise, in some embodiments, the separation device 1100 can include a transporter 1170 that can include the belt 1177 and the flights 1175.

In the illustrated embodiment, one or more of the flights 1175 are each coupled with the belt 1177 via a hinge 1178 of any suitable variety. The hinge 1178 may be biased, such as via a spring or other suitable element to urge the flight 1175 to a natural orientation. The hinge 1178 can permit the flight 1175 to rotate from the natural orientation, which is depicted in solid lines in FIG. 18, to a displaced or rotated orientation, which is depicted in broken lines in FIG. 18. In some embodiments, the flights 1175 include a stop or support 1179, which can inhibit or prevent the flight 1175 from rotating in an opposite direction relative to the belt 1177. The support 1179 can aid the flight 1175 in moving collected solids toward the expulsion port 1118.

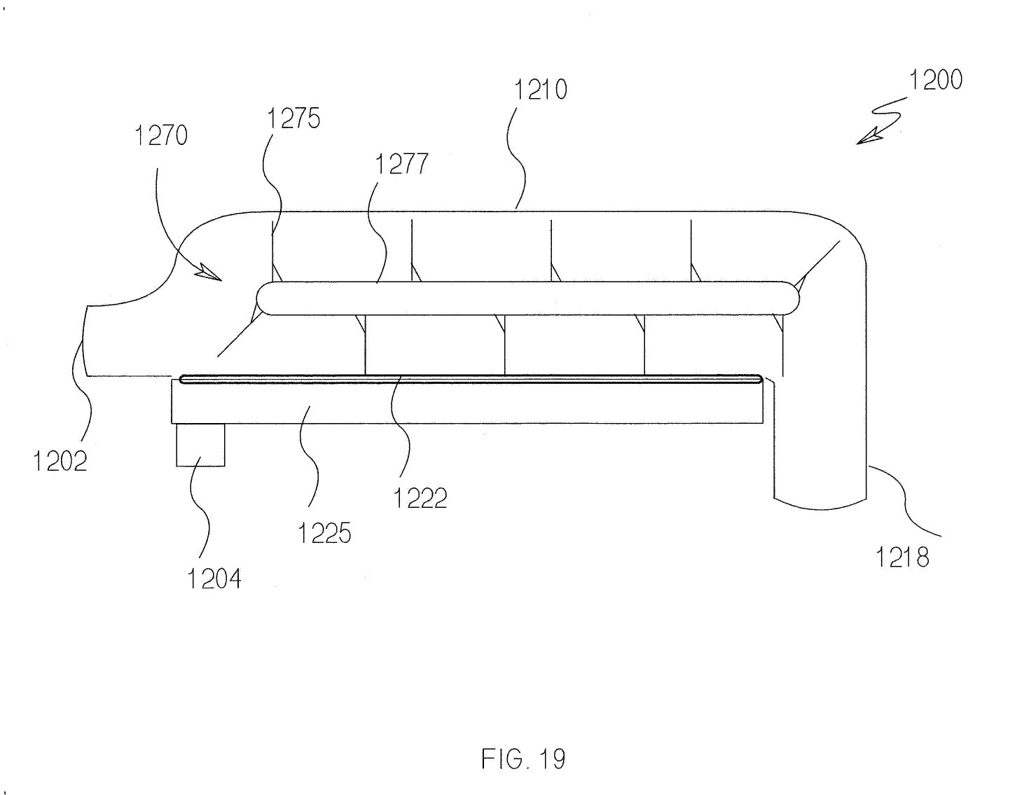

FIG. 19 depicts another embodiment of a separation device 1200 that includes an inlet 1202, a housing 1210, an outlet 1204, a screen 1222, an expulsion port 1218, and a liquid collection chamber 1225. The separation device 1200 similarly includes a belt 1277 and flights 1275. In the illustrated embodiment, the screen 1222 is flexible and is configured to rotate. For example, the screen 1222 can rotate as a belt, and it may do so substantially in unison with the belt 1277 to which the flights 1275 are attached. For example, in some embodiments, the separation device 1200 can include a transporter 1270 that includes the belt 1277 and the flights 1275 attached thereto, as well as the screen 1222. Stated otherwise, in some instances, the belt 1277 and the flights 1275 may move in unison with the screen 1222, which can aid in expulsion or evacuation of the solids from the housing 1210.

As with any suitable embodiment discussed herein, the automated movement of solids toward and/or through the expulsion port 1218 can be provided by a motor or other suitable device. In some instances, the motor is controlled in any suitable manner (e.g., via a controller, other circuit, or other wiring) in a specific operational mode. For example, in some embodiments, the transporter 1270 can be activated and operate concurrently with operation of the garbage grinder and may terminate operation upon termination of the operation of the garbage grinder. In other or further embodiments, the transporter 1270 may operate for a predetermined amount of time after termination of operation of the garbage grinder. In some embodiments, movement of the solids may proceed with a timed delay so as to commence and/or continue for a desired or predetermined amount of time after the disposal unit is turned off.

In certain embodiments of the foregoing separation devices, a closure device (not shown) can be included (such as within the housing, at or near the outlet, etc.) to selectively open and close the expulsion port. Thus, the transportation devices (wheels, belts, etc.) could be manipulated to operate while constituent fluids enter the separation device. The solids portions could then be held within the separation device for a period so as to allow a greater amount of liquid to drain from the solids. This could allow for a lower moisture content of the solids that are ultimately discharged through the expulsion port. At a predetermined time, the closure device is temporarily opened and the transporter portion of the separation device operated to expel the accumulated solids from the separation device.

In any of the foregoing embodiments, expulsion port may be connected to a receptacle, such as the receptacle 91 depicted in and described with respect to FIG. 12. The connection may be achieved in any suitable manner. For example, in some embodiments, the receptacle 91, which may be a bag or other container, may be tied to the expulsion port, or may be tightly gripped against the expulsion port in any other or further manner (e.g., via a rubber band or other elastomeric member). In other or further embodiments, the separation device may be configured to close and/or replace a charged receptacle 91 with an empty receptacle 91.

In any of the foregoing embodiments, the separation device may be equipped with an odor prevention mechanism that prevents odors that may arise within the receptacle 91 and/or the separation device itself from moving through the inlet in a direction toward the sink. For example, although not illustrated in the drawings, in some embodiments, the inlet may include a one-way valve that permits discharge from a sink or garbage disposal to enter the separation device in a first direction. The one-way valve can otherwise form a fluid-tight seal to prevent odors from collected solids portions from passing through the valve in a second direction that is opposite of the first direction.

In general, with respect to any of the foregoing embodiments, the separation devices can include one or more components that assist in separation of liquids and solids portions and/or that assist in movement of the solids portions through the separation devices. In various embodiments, the separation devices can include one or more rotary discs, wheels, drums, belts, and/or baffles. These components can be produced of materials of varying degrees flexibility (whether substantially inflexible, rigid, or hard, or whether relatively flexible or soft), as desired for design purpose. Any suitable number or combination of the separation and/or transportation components is contemplated. The shapes and orientations of the components may also be configured according to the shape and/or configuration of the housing within which they are positioned.

In some embodiments, the separation components can be positioned, can have a desired flexibility, or can otherwise be designed to have a compression effect against the screen. This compression can increase the amount of liquid that is extracted from the solids component that is ultimately expelled through the expulsion port. In some embodiments, the separation components can be raised above the screen to permit an increased flow through the expulsion port.

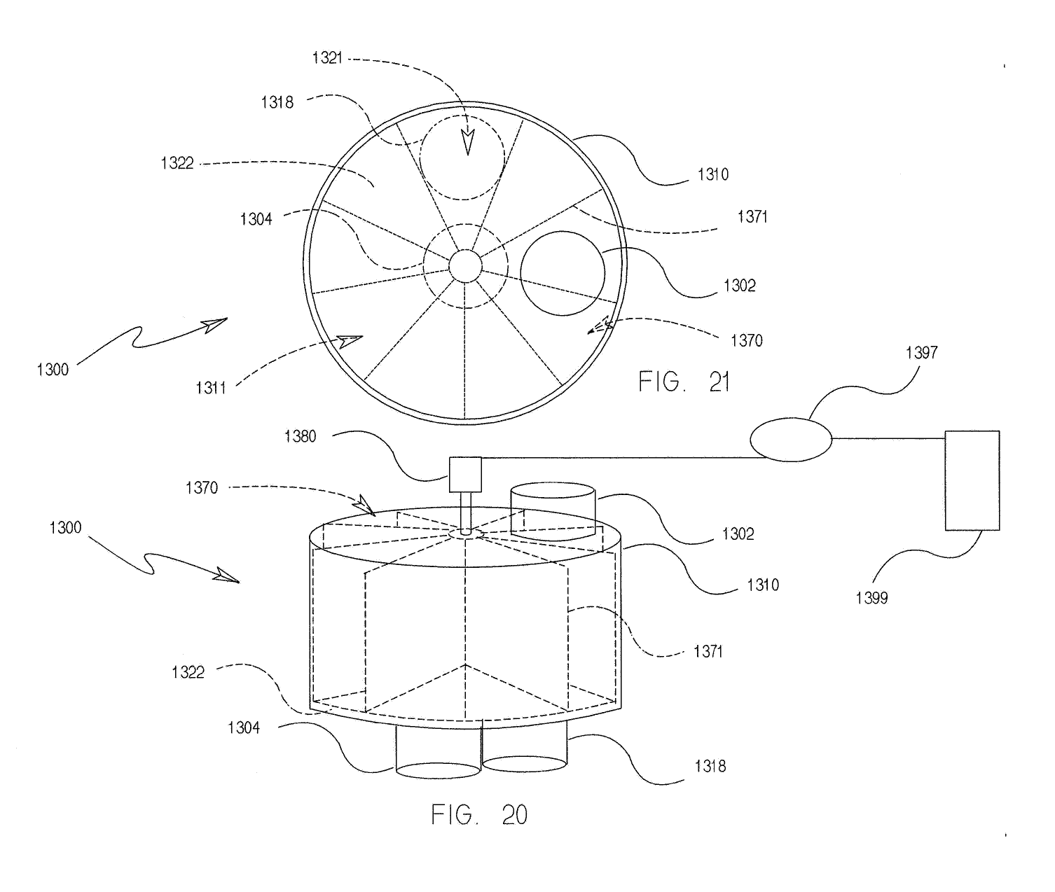

FIGS. 20 and 21 depict another embodiment of a separation device 1300 that includes an inlet 1302, a housing 1310, an outlet 1304, a screen 1322, and an expulsion port 1318. The separation device 1300 may have a more compact design, as compared with certain of the longitudinally elongated embodiments discussed above. In some embodiments, the housing 1310 is a substantially closes structure with discrete openings. For example, the housing 1310 may have an upper wall, a lower wall, and one or more sidewalls. In the illustrated embodiment, the housing 1310 is substantially cylindrical. The inlet 1302, the outlet 1304, and the expulsion port 1318 can be the only openings into or out of the housing 1310, in some embodiments.

The separation device 1300 can include a rotational transporter 1370. In the illustrated embodiment, the transporter 1370 is arranged as a rotary drum that comprises a plurality of partitions, blades, or paddles 1371. The paddles 1371 may extend radially from a central shaft, which may be powered by a torque-generating device 1380 of any suitable variety, such as those discussed above with respect to the torque-generating device 280. In the illustrated embodiment, the paddles 1371 are arranged substantially in a star-like pattern, and are angularly spaced from each other by regular intervals.

In the illustrated embodiment, the sidewall of the housing 1310 is substantially cylindrical, and each paddle 1371 extends substantially to an interior wall of the housing. In some embodiments, each paddle 1371 can be configured to form a substantially fluid-tight seal with the inner wall and to maintain the seal as the paddles 1371 rotate within the housing 1310. Each set of adjacent paddles 1371, a portion of the inner wall of the housing 1310 that extends angularly between the adjacent paddles, and a portion of the screen that extends angularly between the adjacent paddles can cooperate to form a segment, cavity, or receptacle 1311 into which discharge can be received from the inlet 1302. In the illustrated embodiment, the inlet 1302 is positioned at an upper end of the housing 1310, such that the discharges drop from the upper end of the compartments onto the screen 1322. The discharge that is thus held within the receptacle 1311 can be separated, such that the solids portions remain in the receptacle 1311 and the liquid portions drain through the screen 1322 and are expelled via the outlet 1304.

The screen 1322 may be fixed in place, such that the paddles 1371 rotate relative to the screen 1322. In some embodiments, the screen 1322 may be substantially rigid. The screen 1322 may define an opening 1321, which can provide an entry into the expulsion port 1318. One or more of the paddles 1371 may be in direct contact with the upper surface of the screen 1322. In other or further embodiments, one or more of the paddles 1371 may be spaced slightly above the screen 1322, but may still be able to urge the dewatered solids portions toward the opening 1321.

In operation, effluent or discharge directly from a sink or from a disposal unit enters the inlet 1302 and drops into one or more of the receptacles 1311, depending on the position of the rotary drum 1370 and/or whether the rotary drum 1370 is moving as the discharge enters the separation device 1300. For example, in some instances, the discharge may enter into a single receptacle 1311. In other instances, the discharge may enter into two neighboring receptacles 1311 simultaneously, such as when a paddle 1371 is positioned beneath the inlet 1302. Accordingly, in various embodiments, a plurality of receptacles 1311 can be filled simultaneously or in series. The discharge that is positioned in one or more receptacles 1311 is separated into its liquid and solids components via the screen 1322. The liquids drain through the screen 1322 and then out of the separation device 1300 via the outlet 1304. The torque-generating device 1380 causes the paddles 1371 to rotate, thus rotating the receptacles 1311. The paddles 1371 urge the solids portions of the discharge toward the opening 1321 in the screen 1322. When the receptacle 1311 is above the opening 1321, the solids portion can fall through the opening 1321 and through the expulsion port 1318. In the illustrated embodiment, the opening 1321 and the expulsion port 1318 are substantially circular. In other embodiments, the opening 1321 and at least an entry mouth of the expulsion port 1318 may be shaped to substantially correspond with a shape defined by the bottom of the receptacle, such as a substantially wedge- or triangle-shape having a rounded outer edge in the illustrated embodiment. Such an arrangement may facilitate removal of the solids portions from the receptacles 1311. That is, when a receptacle 1311 is positioned above the opening 1321, the solids may more readily drop through the opening 1321.

It can be desirable for the discharge to be rotated about a large portion of the screen 1322 to assist with the removal of fluids from the solids portion. In the illustrated embodiment, the paddles are moved in a clockwise direction (from the top-plan view perspective shown in FIG. 21), to move the solids portion over a greater portion of the screen 1322 than would occur if the paddles were instead moved in a counter-clockwise direction. In other embodiments, the inlet 1302 and the expulsion port 1318 could be situated differently, and a counter-clockwise rotation could instead be desired. In some embodiments, the screen 1322 includes holes that extend in the direction of the drum rotation to facilitate the ground solids passing over the surface of the screen 1322.

In the illustrated embodiment, the torque-generating device 1380 comprises an electrical motor, which is controlled by a controller 1397 of any suitable variety. The controller 1397 and/or the torque-generating device 1380 may be powered by a power source 1399 of any suitable variety. For example, the power source 1399 may comprise the electrical wiring of a home, a local battery, a power feed from a disposal unit, etc.

The controller 1397 can be configured to power the torque-generating device 1380 according to any desired pattern. For example, in some embodiments, delayed rotation may be desired. In other embodiments, rotation that is concurrent with operation of the disposal unit may be desired.

In some embodiments, the controller 1397 is omitted. For example, in some embodiments, the power source 1399 comprises a power feed from a disposal unit, and the torque-generating device 1380 may be configured to operate only during those times that the disposal unit operates.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

References to approximations are made throughout this specification, such as by use of the terms “about” or “approximately.” For each such reference, it is to be understood that, in some embodiments, the value, feature, or characteristic may be specified without approximation. For example, where qualifiers such as “about,” “substantially,” and “generally” are used, these terms include within their scope the qualified words in the absence of their qualifiers. For example, where the term “substantially the same” is recited with respect to a feature, it is understood that in further embodiments, the feature can be precisely the same.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

1. A separation device comprising:
a housing defining a cavity into which a discharge from a sink or from a garbage disposal unit can be received;
an inlet in fluid communication with the cavity of the housing, wherein the inlet is configured to permit the discharge from the sink or the garbage disposal unit to enter the cavity of the housing;
a screen at an interior of the cavity of the housing that is configured to permit a fluid portion of the discharge from the sink or the garbage disposal unit to pass through the screen and is configured to collect within the cavity of the housing a solids portion of the discharge that does not pass through the screen;
a channeling member at an interior of the cavity of the housing, wherein the channeling member defines at least a portion of a flow path and is configured to receive the fluid portion of the discharge from the screen and conduct the fluid portion along the flow path; and
an outlet in fluid communication with the flow path defined by the channeling member, wherein the outlet is configured to permit the fluid portion of the discharge to exit from the cavity of the housing.

2. The separation device of claim 1, further comprising an expulsion port that is configured to selectively permit the solids portion of the discharge to be expelled from the cavity of the housing.

3. The separation device of claim 2, wherein the expulsion port comprises an opening defined by the housing and a cover that is selectively coupled to the housing at the opening, and wherein the cover is configured to be removed from the housing to permit the solids portion of the discharge to be expelled from the cavity of the housing.

4. The separation device of claim 3, wherein the screen is configured to be removed from the cavity of the housing when the cover is removed from the housing to provide access to the solids portion of the discharge that is collected by the screen.

5. The separation device of claim 3, wherein an outer perimeter of each of the screen and the channeling member fits tightly with an inner perimeter of the housing to define a fluid-tight seal therewith, and wherein each of the screen and the channeling member is configured to be removed from the cavity of the housing when the cover is removed from the housing.

6. The separation device of claim 1, further comprising a screening partition that at least partially defines a fluid collection chamber, wherein the channeling member and the fluid collection chamber are at opposite sides of the screening partition, wherein the screening partition is configured to permit fluid that travels along a fluid channel defined by the channeling member to pass through the screening partition into the fluid collection chamber, and wherein the fluid collection chamber is in fluid communication with the outlet.

7. The separation device of claim 1, wherein each of the screen and the channeling member extends about a screening post through which the fluid portion of the discharge, but not the solids portion of the discharge, is permitted to pass.

8. The separation device of claim 1, wherein each of the screen and the channeling member is helically shaped.

9. The separation device of claim 1, wherein the inlet is higher than the outlet when the separation device is installed, wherein the screen is elongated in a downward direction, and wherein the inlet port is situated relative to the screen such that the solids portion of the discharge that does not pass through the screen is moved downwardly away from the inlet port when a subsequent discharge from the sink or the garbage disposal unit is introduced into the separation device via the inlet port.

10. The separation device of claim 1, wherein the screen comprises an upper surface and a lower surface when the separation device is installed, wherein the inlet port is situated relative to the screen such that the solids portion of the discharge that does not pass through the upper surface of the screen at a first position is advanced over the upper surface of the screen to a second position when a subsequent discharge from the sink or the garbage disposal unit is introduced into the separation device via the inlet port, and wherein the second position is further away from the inlet port than is the first position

11. The separation device of claim 1, wherein the housing defines an inner profile and each of the screen and the channeling member defines an outer profile that is complementary to the inner profile of the housing, and wherein the inner profile of the housing is one of circular, oval, rectangular, and hexagonal.

12. The separation device of claim 1, further comprising a discharge channel at least partially defined by the screen, wherein the discharge channel extends in a downward direction away from the inlet.

13. The separation device of claim 12, wherein the flowpath is both separate from the discharge channel and in fluid communication with the outlet.

14. A separation device comprising:
a housing defining a cavity into which a discharge from a sink or garbage disposal unit can be received;
an inlet in fluid communication with the cavity of the housing, wherein the inlet is configured to permit entry of the discharge from the sink or garbage disposal unit into the cavity of the housing;
a conical or frustoconical screen disposed within the cavity of the housing, wherein the screen is configured to permit a fluid portion of the discharge to pass through the screen and to prevent a solids portion from passing through the screen; and
an outlet in fluid communication with the cavity of the housing, wherein the outlet is disposed lower than the inlet when the separation device is installed and configured to be coupled with a waste line to permit the fluid portion of the discharge to exit from the cavity through the waste line;
wherein the separation device is configured to permit removal of the solids portion by removing the conical or frustoconical screen from the separation device.

15. The separation device of claim 14, wherein
the housing comprises a first portion and a second portion; and
the separation device comprises a latch that is configured to couple the first portion of the housing to the second portion of the housing.

16. The separation device of claim 15, wherein the first portion of the housing comprises a baffle that, when the first portion of the housing is coupled to the second portion of the housing, is disposed to slow lateral movement the discharge from the sink or garbage disposal unit.

17. The separation device of claim 15, wherein the separation device is not configured to be coupled to an external power source to facilitate separation of the solids portion from the liquids portion.

18. A separation device comprising:
a housing defining a cavity into which a discharge from a sink or a garbage disposal unit can be received;
an inlet in fluid communication with the cavity of the housing, wherein the inlet is configured to permit entry of the discharge from the sink or the garbage disposal unit into the cavity of the housing;
an outlet in fluid communication with the cavity of the housing, wherein the outlet is configured to be coupled to a waste line to permit the fluid portion of the discharge to exit from the cavity through the waste line; and
a screen disposed between the inlet and the outlet, wherein the screen is configured to permit a fluid portion of the discharge to pass through the screen and to prevent a solids portion from passing through the screen;
an expulsion port configured to permit the solids portion of the discharge to be expelled from the cavity of the housing; and
a plurality of a paddles that are configured to travel along a closed loop and facilitate movement of the solids portion toward the expulsion port.

19. The separation device of claim 18, wherein the expulsion port is disposed below both the screen and the inlet.

20. The separation device of claim 18, wherein the plurality of paddles are configured to rotate about a central shaft.

21. The separation device of claim 20, wherein the separation device is configured to couple the central shaft to a torque-generating device.
